(19) United States
(12) Patent Application Publication
(10) Pub. No.: US 2014/0240612 A1
(43) Pub. Date: Aug. 28, 2014

(54) DISPLAY DEVICE, TELEVISION DEVICE, AND METHOD OF MANUFACTURING DISPLAY DEVICE

(71) Applicant: Sharp Kabushiki Kaisha, Osaka-shi, Osaka (JP)

(72) Inventors: Akira Gotou, Osaka-shi (JP); Masashi Yokota, Osaka-shi (JP)

(73) Assignee: Sharp Kabushiki Kaisha, Osaka-shi, Osaka (JP)

(21) Appl. No.: 14/349,408

(22) PCT Filed: Oct. 24, 2012
(86) PCT No.: PCT/JP2012/077412

§ 371 Date: Apr. 3, 2014

(30) Foreign Application Priority Data
Oct. 31, 2011 (JP) 2011-239570

(51) Int. Cl. F21V 9/08; F21V 8/00; H04N 9/30; F21K 99/00

(52) U.S. Cl. CPC F21V 9/08; F21K 99/00; G02B 6/0068; F21K 9/56; F21K 9/90; H04N 9/30
USPC 348/791; 362/97.4; 362/613; 362/84; 29/832

(57) ABSTRACT

A liquid crystal display device (a display device) 10 includes a liquid crystal panel (a display panel) 11 displaying an image, a backlight unit (a lighting unit) 12 irradiating light to the liquid crystal panel 11, a plurality of LEDs (light sources) 17 that are a light emission source of the backlight unit 12, and a LED board 18 included in the backlight unit 12 and on which the LEDs 17 are mounted. The LEDs 17 are classified into at least three color regions 50 that are arranged in adjacent to each other in a CIE 1931 chromaticity diagram based on chromaticity of emission light. The LEDs are arranged on the LED board 18 such that at least two LEDs 17 in at least two color regions 50 that are positioned symmetrically with respect to a center of at least three color regions 50 in the CIE 1931 chromaticity diagram are arranged in adjacent to each other.

### TECHNICAL FIELD

The present invention relates to a display device, a television device, and a method of manufacturing a display device.

### BACKGROUND ART

Displays components in image display devices, such as television devices, are now being shifted from conventional cathode-ray tube displays to thin display panels, such as liquid crystal panels and plasma display panels. This reduces a thickness of image display devices. Liquid crystal panels included in the liquid crystal display devices do not emit light, and thus backlight devices are required as separate lighting devices. The backlight devices using LEDs as the light source have been known as described in Patent Document 1.
Patent Document 1: Japanese Unexamined Patent Publication No. 2004-88003

### Problem to be Solved by the Invention

In the technology described in Patent Document 1, the LEDs are classified based on the chromaticity and each of the classified LEDs is dyed to form a dyed layer. This weakens chromaticity of unnecessary emission color components to correct the chromaticity.

However, in the technology described in Patent Document 1, a dying process is necessary to be performed during a process of manufacturing LEDs, and this lowers productivity and increases a manufacturing cost. If the LEDs are classified based on the chromaticity and only the LEDs having suitable chromaticity are selectively used, some LEDs are not used and this lowers a yield ratio of the LEDs and increases the manufacturing cost.

### DISCLOSURE OF THE PRESENT INVENTION

The present invention was made in view of the foregoing circumstances. An object of the present invention is to reduce a cost.

### Means for Solving the Problem

A display device of the present invention includes a display panel displaying an image, a lighting unit configured to irradiate the display panel with light, a plurality of light sources that are a light emission source of the lighting unit and configured to be classified into at least three groups based on chromaticity of emission light such that each of the light sources is in one of at least three color regions that are arranged in adjacent to each other in a CIE 1931 chromaticity diagram, and a light source board included in the lighting unit and on which the light sources are arranged such that at least two light sources in at least two color regions that are positioned symmetrically with respect to a center of the at least three color regions in the CIE 1931 chromaticity diagram are arranged in adjacent to each other.

At least two light sources in at least two color regions that are positioned symmetrically with respect to a center of the at least three color regions in the CIE 1931 chromaticity diagram are arranged on the light source board. With this configuration, illumination light of the lighting unit that is obtained by mixing emission light from each of the light sources mounted on the light source board has chromaticity that is effectively averaged. Therefore, unevenness in coloring of an image displayed on the display panel is less likely to occur. This achieves sufficient display quality. This improves the yield ratio relating the light sources and the process of independently adjusting white balance of an image displayed on the display panel is not necessary to be performed in the process of manufacturing the display device. This effectively reduces the manufacturing cost for the display device.

The display device of the present technology may be preferably have following configurations.

(1) The light sources may be classified into at least four groups based on the chromaticity of the emission light such that each of the light sources is in one of at least four color regions that are arranged in a matrix in the CIE 1931 chromaticity diagram, and at least two light sources in a least two of the at least four color regions that are diagonally positioned in the CIE 1931 chromaticity diagram may be arranged in adjacent to each other on the light source board. With such a configuration, among at least four color regions that are positioned in a matrix in the CIE chromaticity diagram, two color regions are positioned symmetrically with respect to a point but not diagonally positioned. Compared to a configuration in which two light sources that are in the two color regions are mounted on the light source board, the chromaticity of the illumination light from the lighting unit that is obtained by mixing light from the light sources mounted on the light source board is further effectively averaged. Accordingly, the unevenness in coloring of the image displayed on the display panel is further less likely to occur and display quality is further improved.

(2) The at least two light sources in the two of the at least four color regions that are diagonally positioned in the CIE 1931 chromaticity diagram may be alternately and in adjacent to each other on the light source board. With such a configuration, compared to a configuration in which the four light sources that are in the diagonally positioned four color regions are arranged on the light source board, the unevenness in color of the illumination light from the lighting unit obtained by mixing the light from the light sources on the light source board is further less likely to occur and the unevenness in coloring of an image displayed on the display panel is further less likely to occur. Further, the light source board has a small variety of light sources and this effectively reduces a management cost regarding mounting of the light sources.

(3) The at least two light sources in the at least two color regions that are positioned symmetrically with respect to the center of the at least three color regions in the CIE 1931 chromaticity diagram may be arranged alternately and in adjacent to each other on the light source board. With such a configuration, compared to a configuration in which four or more light sources in four or more color regions that are positioned symmetrically with respect to a point, the unevenness in color of the illumination light from the lighting unit obtained by mixing light from the light sources on the light source board is further less likely to occur and the unevenness in coloring of an image displayed on the display panel is further less likely to occur. Further, the light source board has a small variety of light sources and this effectively reduces a management cost regarding mounting of the light sources.

(4) The light sources may include a light source that is in the color region including the center of the at least three color regions in the CIE 1931 chromaticity diagram, and the light source in the color region including the center of the at least three color regions may be arranged on the light source board. With such a configuration, at least two light sources in at least two color regions that are positioned symmetrically with respect to the center of the at least three color regions in the CIE 1931 chromaticity diagram and the light source in the color region including the center are arranged on the light source board. Therefore, the chromaticity of the illumination light from the lighting unit is further effectively averaged. Accordingly, the unevenness in images displayed on the display panel is less likely to occur and this improves display quality.

(5) The light source board may be mounted such that the light sources are arranged locally near an end portion of the display panel of the lighting unit and arranged along the end portion of the display panel. In such a lighting unit of the edge-light type, compared to a direct-type lighting unit in which the light source board and the light sources are arranged to face a plate surface of the display panel, the interval between the light sources on the light source board reduces. Therefore, light from the light sources that are in the different color regions are easily mixed. Accordingly, unevenness in color of the illumination light from the lighting unit is less likely to occur and unevenness in coloring in an image displayed on the display panel is further less likely to occur.

(6) The light sources may be classified into at least four kinds based on the chromaticity of the emission light such that each of the light sources is in one of the at least four color regions that are positioned in a matrix in the CIE 1931 chromaticity diagram, and the display panel may include a display area displaying an image, and a non-display area surrounding the display area. When a ratio of a distance L from the light source on the light source board to the display area and an interval P between the light sources on the light source board may satisfy relation of a following formula (1), the at least four light sources in the at least four color regions that are positioned symmetrically with respect to the center of the at least four color regions in the CIE 1931 chromaticity diagram may be arranged in adjacent to each other on the light source board.

[Formula 1]

L/P≧0.25 (1)

As the distance L between the light sources and the surface of the display area increases, the mixing rate of the light from the light sources increases and difference in the chromaticity of each light source is unlikely to be recognized. As the distance L decreases, the mixing rate of the light lowers and the difference in the chromaticity of each light source is likely to be recognized. As the interval P between the light sources increases, the light from the light sources is unlikely to be mixed. As the interval P decreases, the light from the light sources is likely to be mixed. With considering the above, if the ratio of the distance L and the interval P satisfies the formula (1), compared to the light source board on which only two kinds of light sources in the two color regions that are positioned symmetrically with respect to a point, the light source board that includes at least four light sources that are likely to relatively cause unevenness in color is effectively used. The light source board having such a configuration is used and accordingly, various kinds of light sources can be used. This improves the yield ratio of the light sources and reduces a cost.

(7) The lighting unit may further include a light guide plate having an end surface that faces the light sources and a plate surface that faces a plate surface of the display panel. With such a configuration, light emitting from each light source arranged on the light source board enters the end surface of the light guide plate and travels through the light guide plate. Thereafter, the light exits from the plate surface of the light guide plate toward the plate surface of the display panel. With the configuration in which the light sources that are in the different color regions are arranged on the light source board, the light from the light sources is effectively mixed within the light guide plate and exits therefrom toward the display panel. Accordingly, unevenness in coloring of an image displayed on the display panel is further less likely to occur and this improves display quality.

(8) The light source may include a light emission component that emits visible light and a phosphor that is excited by light from the light emission component and emits light. With such a configuration, the light source including the light emission component that emits visible light uses the visible light as the exciting light for the phosphor and as the emission light from the light source. Therefore, if the variation in the main emission wavelength of each light emission component occurs in manufacturing the light sources and the visible light from the light emission component is irradiated to the display panel as the illumination light of the lighting unit, the chromaticity of an image displayed on the display panel is likely to be varied. Even if such light sources are used, at least two light sources in at least two color regions are positioned symmetrically with respect to the center of at least three color regions in the CIE 1931 chromaticity diagram are arranged on the light source board and therefore, the unevenness in coloring of the image displayed on the display panel is less likely to occur.

(9) The light source may include the light emission component that emits blue light and the phosphor that is excited by the blue light from the light emission component and emits white light as a whole. With such a configuration, the light source including the light emission component that emits blue light is used to effectively provide white light as the whole emission light and a cost for manufacturing the light sources is reduced. This further reduces a cost for manufacturing the display device.

(10) The display panel may further include a color filter including coloring portions that provides blue, green, red, and yellow. With such a configuration, the color filter includes a yellow coloring portion in addition to coloring portions of the primary three colors of blue, green, and red. This expands the color reproduction range that can be perceived by human beings, that is, the color gamut, and the color reproducibility of colors of objects existing in nature is improved. This improves display quality. Among the coloring portions included in the color filter, the light passed through the yellow color portion has a wavelength close to a visible peak. Therefore, human beings tend to perceive the light as bright light having great brightness even though the light is emitted with low energy. Accordingly, sufficient brightness still can be achieved with reduced output of the light sources. This reduces the power consumption of the light sources and improves environmental efficiency. In display panel including the color filter having the yellow coloring portion, light exiting from the display panel or an overall color of the display images displayed on the display panel tend to be yellowish. To solve this problem, the chromaticity of the emission light from the light sources included in the lighting unit is adjusted to be bluish. Blue is a complementary color of yellow. However, if the main emission wavelength of each of the light emission components varies in manufacturing the light sources, the chromaticity of the display images displayed on the display panel is more likely to be varied. According to the present embodiment, two kinds of light sources in at least two color regions positioned symmetrically with respect to a center of at least three adjacent color regions in the CIE 1931 chromaticity diagram are arranged on the light source board. With such a configuration, the unevenness in coloring of the display image displayed on the display panel is less likely to occur.

(11) The light source may be an LED. This improves brightness and lowers consumption power.

Next, to solve the above problem, a method of manufacturing a display device of the present technology includes a light source classification process in which light sources are classified into at least three groups based on chromaticity of emission light from each of the light sources such that each of the light sources is in one of at least three color regions that are positioned in adjacent to each other in the CIE 1931 chromaticity diagram, a light source mount process in which at least two light sources in at least two color regions that are positioned symmetrically with respect to a center of the at least three color regions in the CIE 1931 chromaticity diagram are arranged in adjacent to each other on the light source board, and a mount process in which the light source board is mounted to a lighting unit and a display panel is mounted to the lighting unit.

Thus, in the light source classifying process, each of the light sources is classified to be in one of the at least three color regions that are located in adjacent to each other in the CIE 1931 chromaticity diagram based on the chromaticity of the emission light from the light source. In the subsequent light source mount process, at least two light sources that are in at least two color regions positioned symmetrically with respect to the center of at least three color regions in the CIE 1931 chromaticity diagram are arranged in adjacent to each other on the light source board. Thus manufactured light source board is mounted to the lighting unit in the mount process, and accordingly, the chromaticity of the illumination light from the lighting unit that is obtained by mixing the light from the light sources is effectively averaged. Therefore, the unevenness in coloring of an image displayed on the liquid crystal panel 11 that is mounted to the lighting unit is less likely to occur and sufficient display quality is obtained. This improves the yield ratio of the light sources and the white balance of the image displayed on the display panel is not necessary to be adjusted in the mount process. This effectively reduces a cost for manufacturing the display device.

### Advantageous Effect of the Invention

According to the present invention, a cost is reduced.

### BRIEF DESCRIPTION OF THE DRAWINGS

FIG. 1 is an exploded perspective view illustrating a general construction of a television receiver according to a first embodiment of the present invention.

FIG. 2 is an exploded perspective view illustrating a general construction of a liquid crystal display device included in the television receiver.

FIG. 3 is a cross-sectional view illustrating a cross-sectional configuration of the liquid crystal display device along the long-side direction.

FIG. 4 is a magnified view of an array board illustrating a plan-view configuration.

FIG. 5 is a magnified view of a CF board illustrating a plan-view configuration.

FIG. 6 is a plan view illustrating an arrangement construction of a chassis, a light guide plate, and an LED board in a backlight unit included in the liquid crystal display device.

FIG. 7 is a cross-sectional view taken along a vii-vii line in FIG. 6.

FIG. 8 is a cross-sectional view illustrating the LED and the LED board.

FIG. 9 is a graph representing transmission spectra of a color filter included in the liquid crystal panel.

FIG. 10 is a CIE 1931 chromaticity diagram.

FIG. 11 is a CIE 1931 chromaticity diagram illustrating a chromaticity when each of the LEDs independently emits light.

FIG. 12 is a CIE 1931 chromaticity diagram illustrating a chromaticity obtained by transmitting through the liquid crystal panel light from each LED that emits light independently.

FIG. 13 is a CIE 1931 chromaticity diagram illustrating a chromaticity obtained by transmitting through the liquid crystal panel light from the LEDs that are included in one LED board that is controlled independently.

FIG. 14 is a front view of a first LED board.

FIG. 15 is a front view of a second LED board.

FIG. 16 is a front view of a third LED board.

FIG. 17 is a front view of a fourth LED board.

FIG. 18 is a front view of a fifth LED board.

FIG. 19 is a front view of an LED board according to a second embodiment of the present invention.

FIG. 20 is a plan view representing a relationship between a distance L from the LEDs to a display area of the liquid crystal panel and an interval P between the LEDs.

FIG. 21 is a front view of an LED board according to a third embodiment of the present invention.

FIG. 22 is a front view of an LED board according to a fourth embodiment of the present invention.

FIG. 23 is an exploded perspective view illustrating a general construction of a television device according to a fifth embodiment of the present invention.

FIG. 24 is a cross-sectional view illustrating a cross sectional construction of a liquid crystal panel along a long-side direction of the liquid crystal panel.

FIG. 25 is a magnified plan view illustrating a plan construction of the array substrate.

FIG. 26 is a magnified plan view illustrating a plan construction of the CF board.

FIG. 27 is a CIE 1931 chromaticity diagram illustrating a definition type of color regions of the LEDs according to a sixth embodiment of the present invention.

FIG. 28 is a CIE 1931 chromaticity diagram illustrating a definition type of color regions of the LEDs according to a seventh embodiment of the present invention.

FIG. 29 is a CIE 1931 chromaticity diagram illustrating a definition type of color regions of the LEDs according to a eighth embodiment of the present invention.

FIG. 30 is a CIE 1931 chromaticity diagram illustrating a definition type of color regions of the LEDs according to a ninth embodiment of the present invention.

FIG. 31 is a CIE 1931 chromaticity diagram illustrating a definition type of color regions of the LEDs according to a tenth embodiment of the present invention.

FIG. 32 is a plan view illustrating an arrangement configuration of the light guide plate and the LED board according to another embodiment (1) of the present invention.

FIG. 33 is a plan view illustrating an arrangement configuration of the light guide plate and the LED board according to another embodiment (2) of the present invention.

FIG. 34 is a plan view illustrating an arrangement configuration of the light guide plate and the LED board according to another embodiment (3) of the present invention.

FIG. 35 is a plan view illustrating an arrangement configuration of the light guide plate and the LED board according to another embodiment (4) of the present invention.

### MODE FOR CARRYING OUT THE INVENTION

### First Embodiment

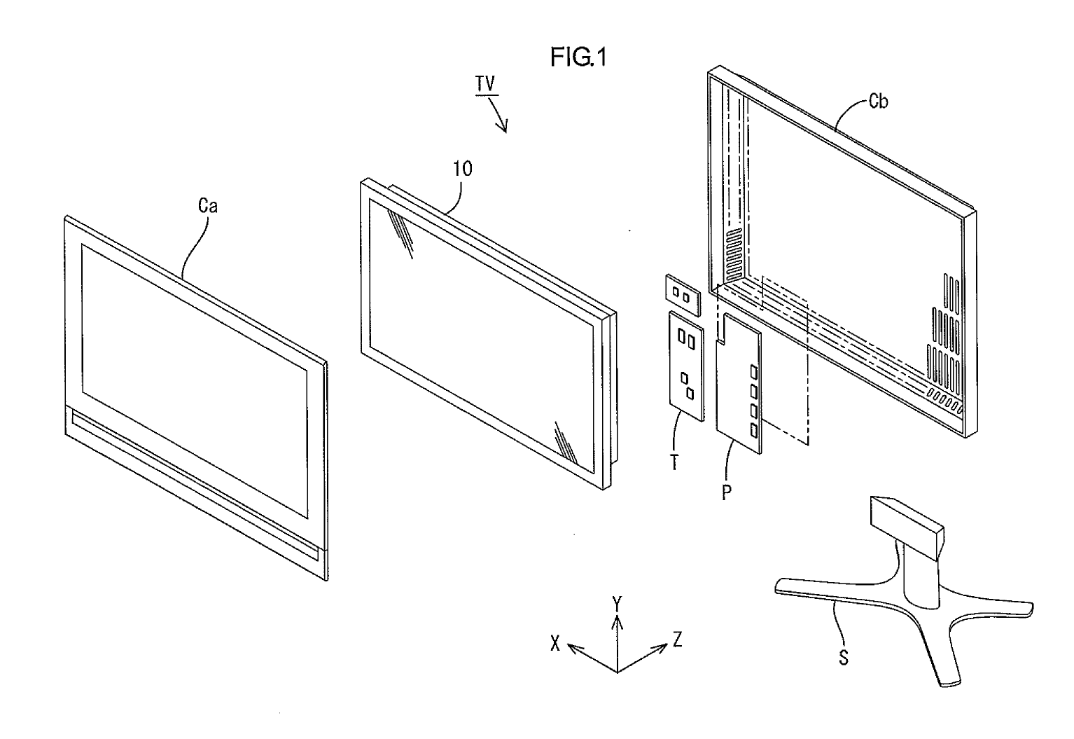

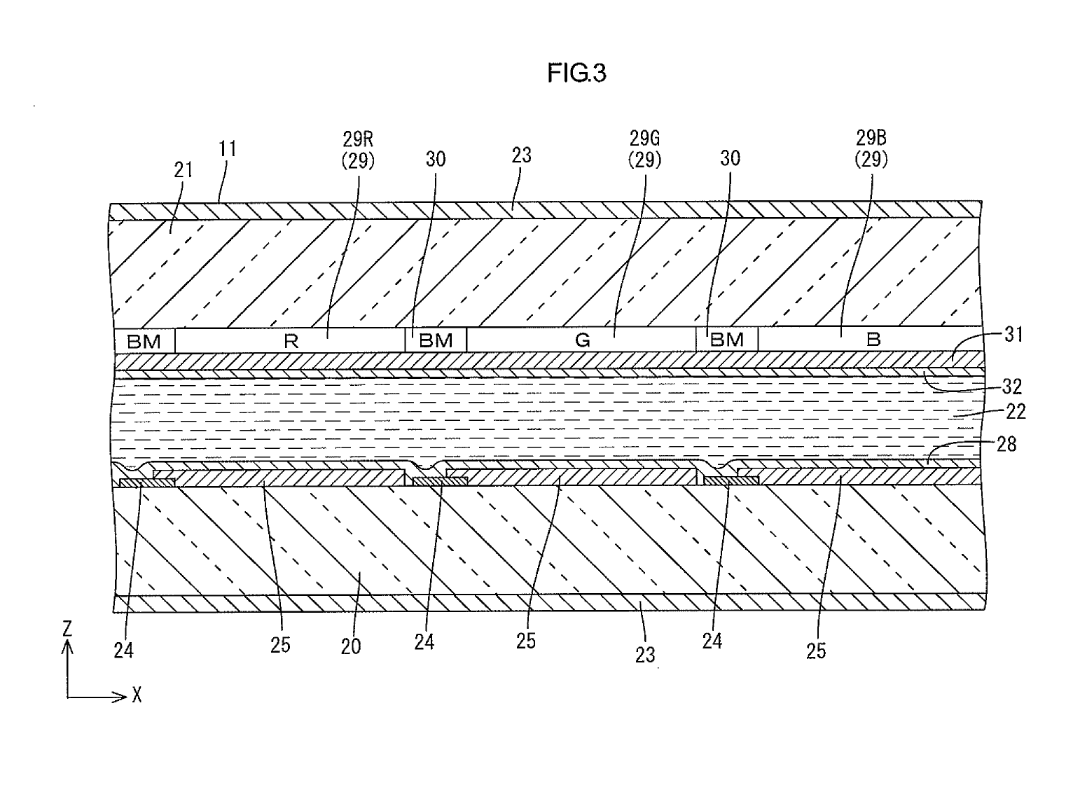

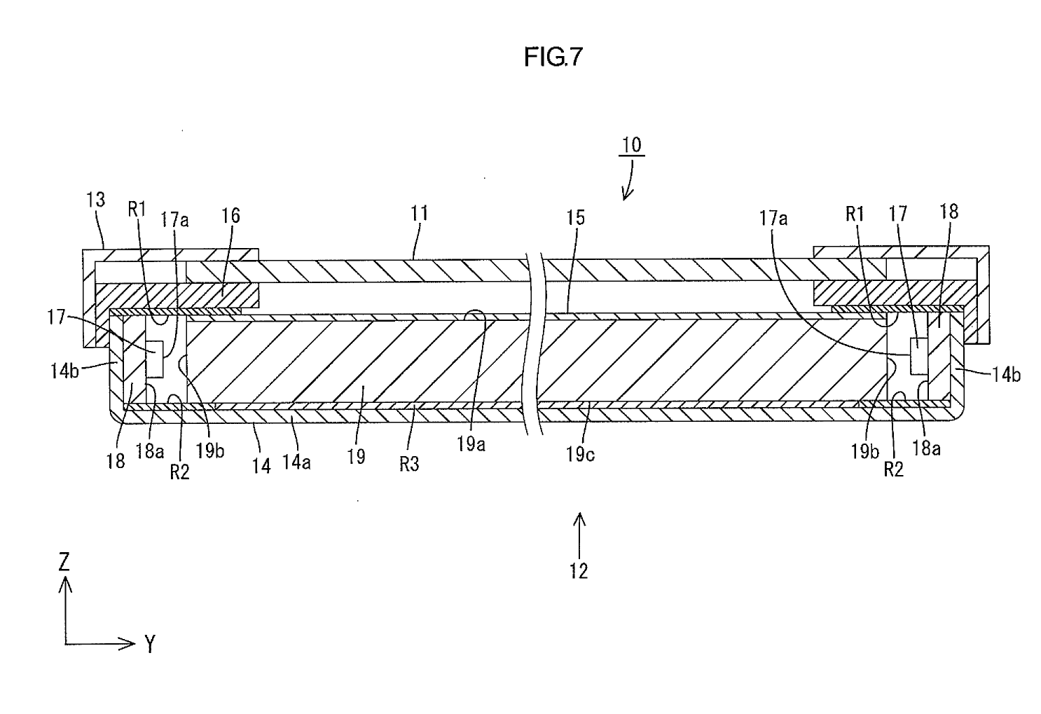

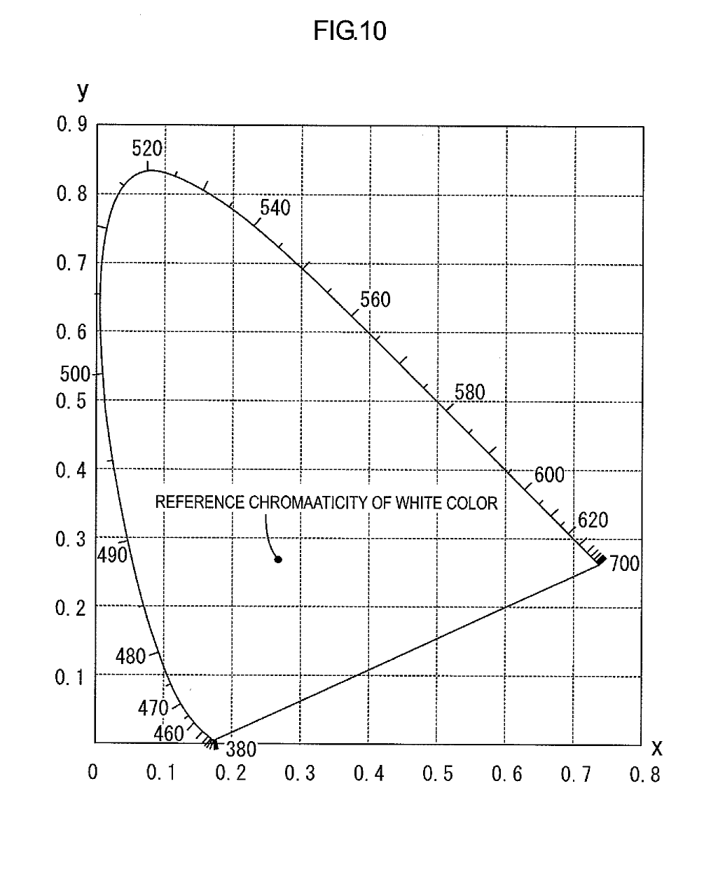

A first embodiment of the present invention will be explained with reference to FIGS. 1 to 18. In this embodiment, a liquid crystal display device 10 will be illustrated. X-axis, Y-axis and Z-axis are indicated in some drawings. The axes in each drawing correspond to the respective axes in other drawings. The upper side and the lower side in FIGS. 3 and 7 correspond to the front side and the rear side, respectively.

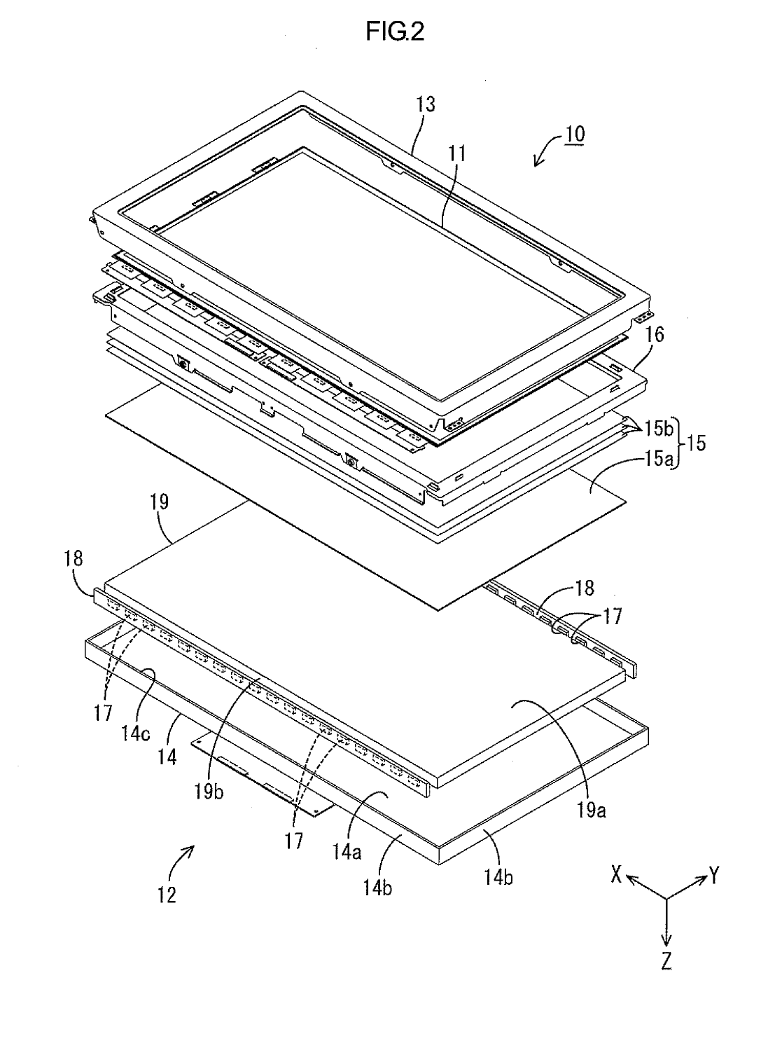

As illustrated in FIG. 1, a television receiver TV of this embodiment includes the liquid crystal display device 10, front and rear cabinets Ca, Cb that house the liquid crystal display device (display device) 10 therebetween, a power source P, a tuner T, and a stand S. An overall shape of the liquid crystal display device (a display device) 10 is a landscape rectangular and the liquid crystal display device 10 is located in a vertical position. As illustrated in FIG. 2, the liquid crystal display device 10 includes a liquid crystal panel 11 as a display panel, and a backlight unit (a lighting unit) 12 as an external light source. They are integrally held by a bezel 13 having a frame-like shape.

The liquid crystal panel 11 will be described in detail. As illustrated in FIG. 3, the liquid crystal panel 11 includes a pair of transparent glass substrates 20, 21 (capable of light transmission) and a liquid crystal layer 22 that is enclosed between the substrates 20 and 21. The liquid crystal layer 22 includes liquid crystals having optical characteristics that vary according to electric fields applied thereto. One of the substrates 20, 21 on a rear-surface side (on a backlight unit 12 side) is an array board (a substrate, an active matrix board) 20, and the other one of the substrates 20, 21 on a front-surface side (light exit side) is a CF board (a counter board) 21. A pair of polarizing plates 23 is bonded to an outer surface of the substrates 20, 21.

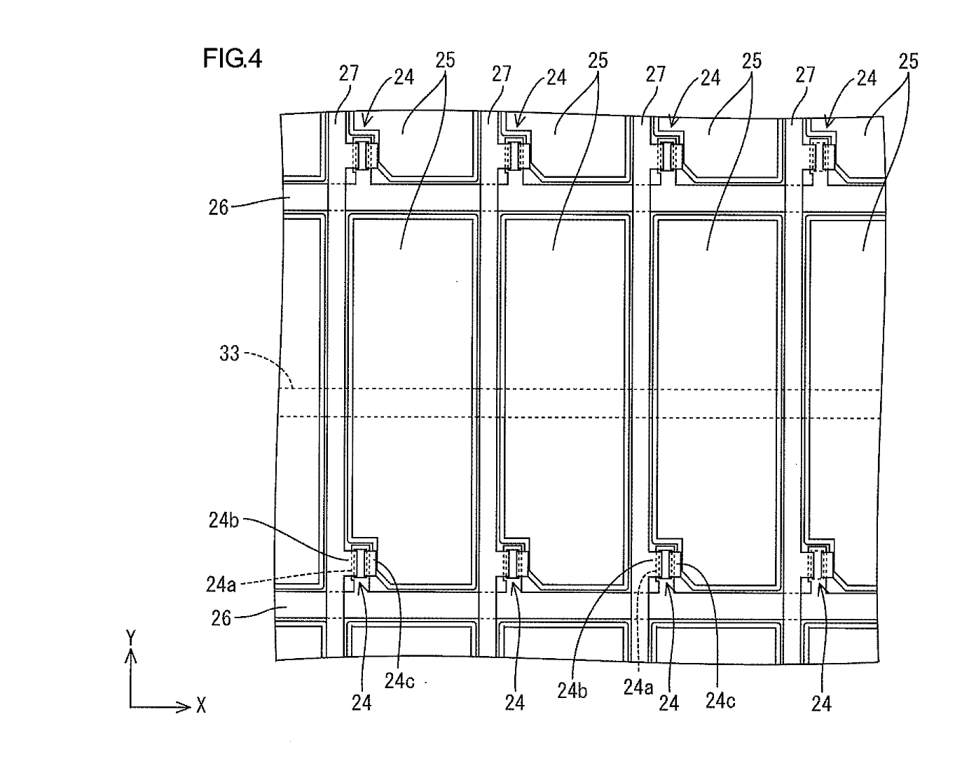

On the inner surface of the array board 20 (a surface closer to the liquid crystal layer 22, a surface opposed to the CF board 21), a number of thin film transistors (TFTs) 24 and pixel electrodes 25 are arranged as illustrated in FIG. 4. The TFTs 24 are switching elements each having three electrodes 24a to 24c. Furthermore, gate lines 26 and source lines 27 are arranged in a matrix around the TFTs 24 and the pixel electrodes 25. The pixel electrode 25 is a transparent conductive film made from indium tin oxide (ITO). The gate lines 26 and the source lines 27 are made from a conductive material. The gate lines 26 and the source lines 27 are connected to gate lines 24a and source lines 24b of the TFTs 24, respectively. The pixel electrodes 25 are connected to drain electrodes 24c of the respective TFTs 24 via a drain line (not illustrated). The array board 20 includes capacity lines (auxiliary capacity lines, storage capacity lines, Cs lines) 33 that are parallel to the gate lines 26 and overlap the pixel electrodes 25 in a plan view. The capacity lines 33 and the gate lines 26 are arranged alternately with respect to the Y-axis direction. The gate line 26 is arranged between the pixel electrodes 25 that are arranged adjacent to each other in the Y-axis direction. Each capacity line 33 is arranged to cross about a middle portion of each pixel electrode 25 in the Y-axis direction. In an end portion of the array board 20, terminals extended from the gate lines 26 and the capacity lines 33 and terminals extended from the source lines 27 are arranged. A signal or a reference potential is input from an external circuit (not illustrated) to each of the terminals. Accordingly, driving of the TFTs 24 is controlled. An alignment film 28 is formed on an inner surface side of the array board 20 (FIG. 3). The alignment film 28 aligns liquid crystal molecules included in the liquid crystal layer 22.

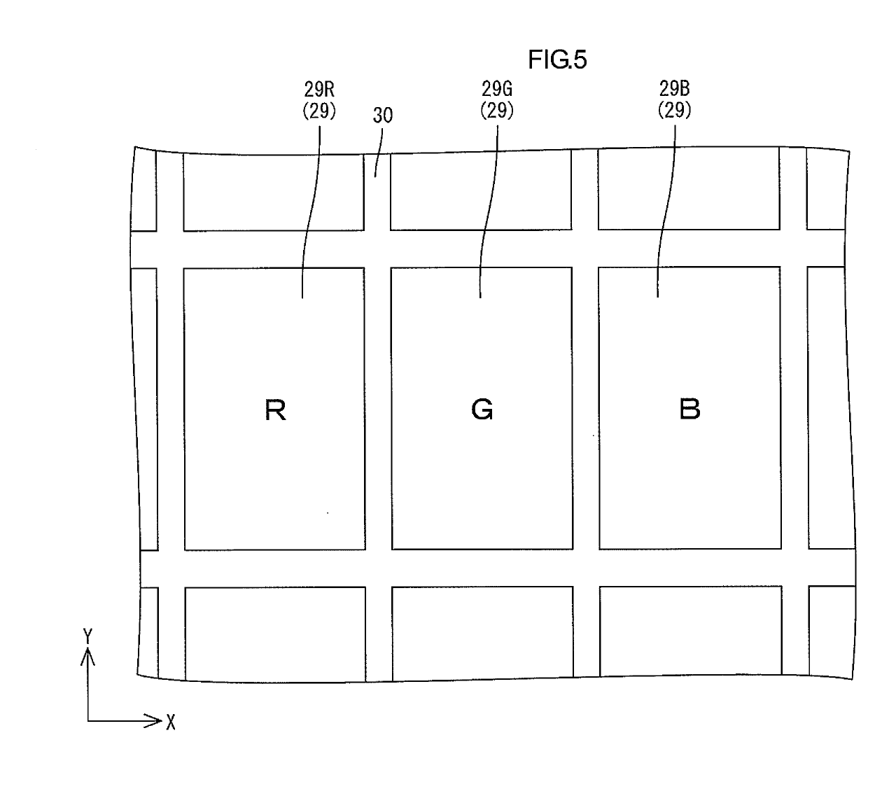

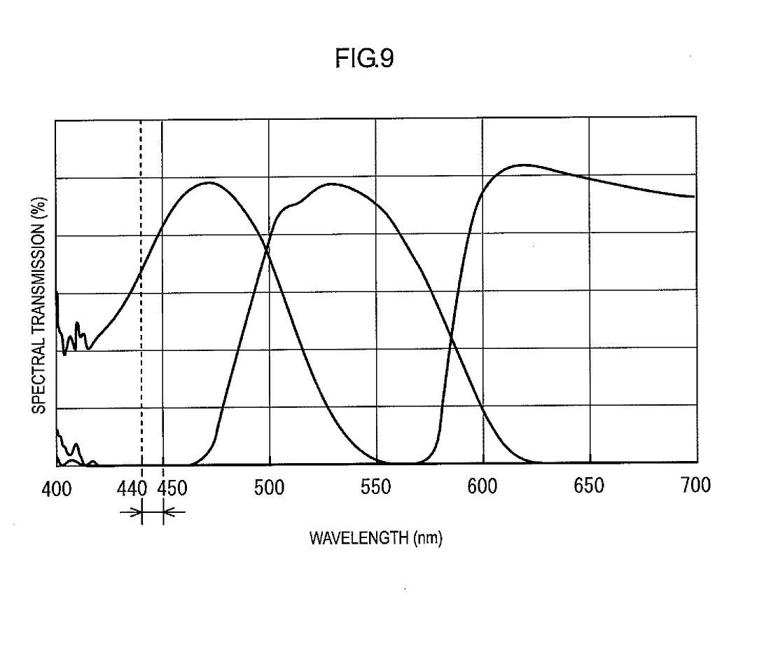

On the inner surface of the CF board 21 (on a surface closer to the liquid crystal layer 22, on a surface opposed to the array board 20), color filters 29 are arranged to overlap the pixel electrodes 25 that are on the array substrate 20 side in a plan view, as illustrated in FIGS. 3 and 5. The color filters 29 include color portions 29R, 29G, 29B that are arranged in a matrix alternately along the X-axis direction. The color portion 29R provides red color, the color portion 29G provides green color, and the color portion 29B provides blue color. The color potions 29R, 29G, 29B selectively pass the respective colors (or wavelengths) of light (FIG. 9). Specifically, the color portion 29R that provides red color passes light having a wavelength range of red (approximately 600 nm to 780 nm), the color portion 29G that provides green color passes light having a wavelength range of green (approximately 500 nm to 570 nm), and the color portion 29B that provides blue color passes light having a wavelength range of blue (approximately 420 nm to 480 nm). Each of the color portions 29R, 29G, 29B has a rectangular shape and a vertically elongated shape following an outer shape of the pixel electrode 25. Alight blocking portion (a black matrix) 30 is formed in a matrix between the coloring portions 29R, 29G, and 29B of the color filter 29 so that colors are less likely to be mixed. The light blocking portion 30 is arranged to overlap the gate lines 26, the source lines 27 and the capacity lines 33 on the array substrate 20 side in a plan view. A counter electrode 31 is arranged on surfaces of the color filters 29 and the light blocking portions 30 so as to be opposed to the pixel electrodes 25 that are arranged on the array substrate 20 side. An alignment film 32 is overlaid on the inner surface of the CF board 21 to align the liquid crystal molecules included in the liquid crystal layer 22.

Next, the backlight unit 12 will be described. As illustrated in FIG. 2, the backlight unit 12 includes a chassis 14, an optical member 15 and a frame 16. The chassis 14 has a box-like shape having an opening 14c on the front-surface side that is a light exit side (on the liquid crystal panel 11 side). The optical member 15 is arranged so as to cover the opening 14c of the chassis 14. The frame 16 presses a light guide plate 19 from the front-surface side. Furthermore, LED boards (light source boards) 18 on which LEDs 17 are mounted as light sources and the light guide plate 19 are arranged inside the chassis 17. The light guide plate 19 is configured to guide light from the LEDs 17 to the optical member 15 (or the liquid crystal panel 11, the light exit side). In the backlight unit 12, the LED board 18 having the LEDs 17 is arranged on each long-side edge of the backlight unit 12 and a pair of LED boards 17 sandwiches the light guide plate 19 with respect to a short-side direction (the Y-axis direction) of the light guide plate 19. The LEDs 17 mounted on each LED board 18 are locally located on each of the long-side edges of the liquid crystal panel 11 and are arranged along the long-side edge or along the long-side direction (the X-axis direction). Thus, the backlight unit 12 of this embodiment is a so-called edge-light-type (or a side-light-type). Components of the backlight unit 12 will be described in detail.

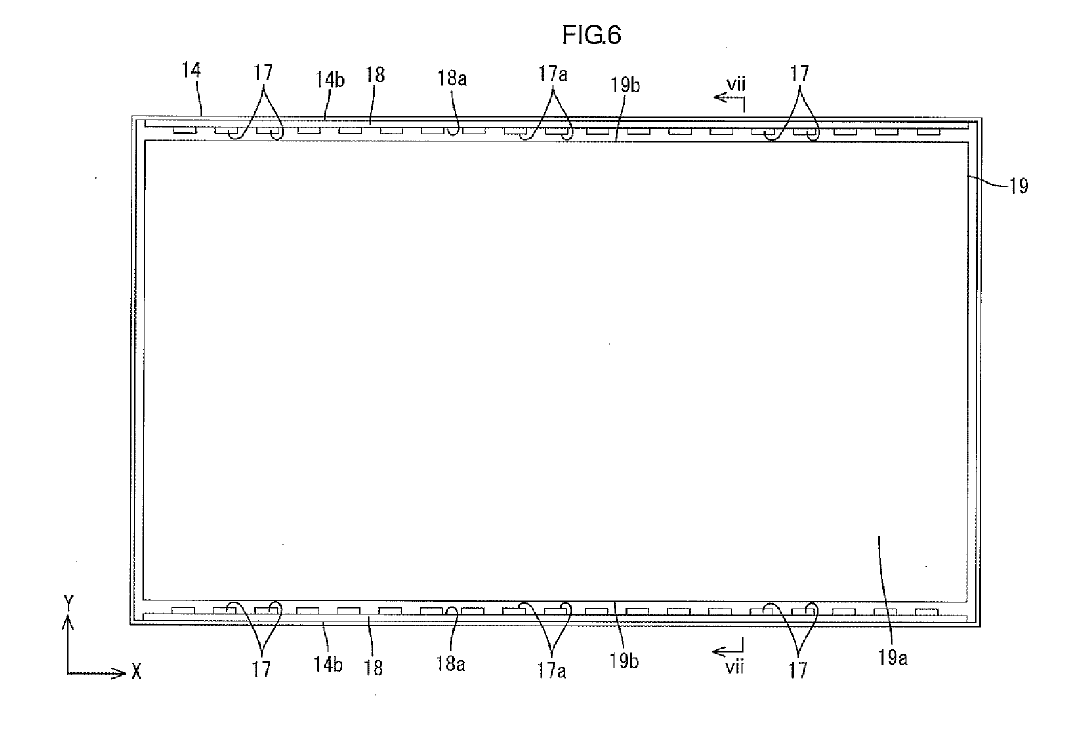

The chassis 14 is formed of a metal plate such as an aluminum plate or an electro galvanized steel sheet (SECC). As illustrated in FIGS. 6 and 7, the chassis 14 includes a bottom plate 14a and side plates 14b. The bottom plate 14a has a rectangular shape similar to the liquid crystal panel 11. Each side plate 14b rises from an outer edge of the corresponding side of the bottom plate 14a. The chassis 14 (the bottom plate 14a) has a long side and a short side that match the X-axis direction (the horizontal direction) and the Y-axis direction (the vertical direction), respectively. A frame 16 and the bezel 13 are fixed to the side plates 14b with screws.

As illustrated in FIG. 2, the optical member 15 has a landscape rectangular plan-view shape similar to the liquid crystal panel 11 and the chassis 14. The optical member 15 is arranged on the front surface of the light guide plate 19 (on the light exit side) between the liquid crystal panel 11 and the light guide plate 19. Light exiting from the light guide plate 19 passes through the optical member 15 and this applies a certain optical effects to the transmitted light. The light passing through the optical member 15 exits toward the liquid crystal panel 11. The optical member 15 includes a diffuser plate 15a and optical sheets 23b. The diffuser plate 15a is arranged on the rear-surface side (the light guide plate 19 side, an opposite side from the light exit side). The optical sheets 15b are arranged on the front-surface side (the liquid crystal panel 11 side, the light exit side). The diffuser plate 15a is constructed of a plate-like member in a specified thickness and made of substantially transparent synthetic resin with light-scattering particles dispersed therein. The diffuser plate 15a disperses the light passing therethrough. Each optical sheet 15b has a sheet-like shape with a thickness smaller than that of the diffuser plate 15a. Three sheets are overlaid with each other. Examples of the optical sheets 15b are a diffuser sheet, a lens sheet and a reflection-type polarizing sheet. Each optical sheet 15b can be selected from those sheets accordingly. In FIG. 7, the three optical sheets 15b are simply described as one sheet.

As illustrated in FIG. 2, the frame 16 has a frame-like shape extending along the periphery of the light guide member 19. The frame 16 holds down substantially entire edges of the light guide plate 19 from the front-surface side. The frame 16 is made of synthetic resin. The front surface of the frame 16 may be in black so as to have a light blocking capability. As illustrated in FIG. 3, a first reflection sheet R1 is mounted to the backsides of the respective long-side portions of the frame 16, that is, surfaces opposed to the light guide plate 19 and the LED boards 18 (or the LEDs 17). The first reflection sheet R1 has a dimension extending for a substantially entire length of the long-side portion of the frame 16. The first reflection sheet R1 is directly in contact with the edge of the light guide plate 19 facing the LEDs 17. The first reflection sheet R1 collectively covers the edge of the light guide plate 19 and the LED board 18 from the front-surface side. The frame 16 receives the outer edges of the liquid crystal panel 11 from the rear-surface side.

As illustrated in FIGS. 2 and 7, each LED 17 is mounted on the LED board 18. A surface of the LED 17 opposite from the LED board 18 is a light emitting surface 17a, that is, the LED 17 is a top light type. A detailed configuration of the LED 17 will be described later. As illustrated in FIGS. 2, 6 and 7, each LED board 18 on which the LEDs 17 are mounted has an elongated plate-like shape extending along the long-side direction of the chassis 14 (the edge portion of the liquid crystal panel 11 and the light guide plate 19 on the LED 17 side, the X-axis direction). The LED board 18 is arranged with the main board surface parallel to the X-Z plane, that is, perpendicular to board surfaces of the liquid crystal panel 11 and the light guide plate 19 (or the optical member 15) and housed in the chassis 14. The LED board 18 is arranged such that a long side of the LED board plate surface matches the X-axis direction and a short side thereof matches the Z-axis direction and a board thickness that is perpendicular to the plate surface matches the Y-axis direction. The LED boards 18 are provided in a pair so as to sandwich the light guide plate therebetween with respect to the Y-axis direction. Specifically, each of the LED boards 18 is arranged between the light guide plate 19 and a long-side plate 14b of the chassis 14. The LED board 18 is mounted to the chassis 14 along the Z-axis direction from the front-surface side. Each LED board 18 has a mount surface 18a on which the LEDs 17 are mounted. Each LED board 18 is mounted such that a plate surface opposite to the mount surface 18a is in contact with an inner surface of the long side plate 14b of the chassis 14. Therefore, the light emission surfaces 17a of the LEDs 17 mounted on the two LED boards 18 face each other and a light axis of the light emitting from each LED 17 substantially matches the Y-axis direction (parallel to a plate surface of the liquid crystal panel 11).

As illustrated in FIGS. 2, 6 and 7, the LEDs 17 (nineteen LEDs in FIG. 6) are arranged on an inner surface of the LED board 18 that faces the light guide plate 19 (a surface opposed to the light guide plate 19) at intervals along the long side of the LED board 18. A line of the LEDs 17 forms an LED group. The LEDs 17 are surface-mounted on the surface of each LED board 18 facing the light guide plate 19 that is a mount surface 18a. A wiring pattern (not illustrated) is formed on the mount surface 18a of the LED board 18. The wiring pattern is made of a metal film (copper foil) and extends along the X-axis direction to connect in series the LEDs 17 that are adjacent to each other across the LED groups. A terminal is formed at two ends of the wiring pattern and the terminals are connected to an external drive circuit to supply driving power to the LEDs 17. The LEDs are mounted on only one surface of the LED board 18 and the LED board 18 has one mount surface 18a. The LED board 18 is a one-surface mount type. Every interval between the LEDs 17 that are arranged adjacent to each other with respect to the X-axis direction is substantially same. Namely, the LEDs 17 are arranged at substantially equal intervals. Specifically, a size of each LED 17 in the X-axis direction (the arrangement direction) is, for example, approximately from 2 mm to 7 mm. An arrangement interval between the LEDs 17 is, for example, approximately from 15 mm to 30 mm. In a direct-mount type backlight unit, an arrangement interval between the LEDs is approximately 50 mm. Compared to the case of such a direct-mount type backlight unit, the arrangement interval between the LEDs 17 of the edge-light type backlight unit 12 of the present embodiment is smaller. In the edge-light type backlight unit, the LEDs 17 are collectively and locally arranged in the end portion of the liquid crystal panel 11 and an area of the liquid crystal panel 11 occupied by the LEDs 17 is smaller than the direct-mount type backlight unit. The substrate of each LED board 18 is made of metal such as aluminum. On the surface of the substrate, the wiring patterns (not illustrated) are formed via an insulating film. A material used for the substrate may be an insulating material such as synthetic resin or ceramics.

Next, the light guide plate 19 is made of synthetic resin (e.g., acrylic) that is nearly transparent (i.e., capable of light transmission at a high level) and has a refraction index higher than that of the air. As illustrated in FIGS. 2 and 6, the light guide plate 19 has a rectangular plan-view flat plate shape similar to the liquid crystal panel 11 and the bottom plate 14a of the chassis 14 and the plate surface of the light guide plate 19 are opposed to plate surfaces of the liquid crystal panel 11 and the optical member 15. The light guide plate 19 has the long sides and the short sides aligned with the X-axis direction and the Y-axis direction, respectively. The light guide plate 19 has a thickness that is perpendicular to the plate surface and aligned with the Z-axis direction. As illustrated in FIG. 7, the light guide plate 19 is arranged directly below the liquid panel 11 and the optical member 15 within the chassis 14. A pair of long-side end surfaces of an outer peripheral surface of the light guide plate 19 faces the LEDs 17 mounted on the respective LED boards 18 that are arranged in the long-side end portions of the chassis 14. An arrangement direction in which the LEDs 17 (or the LED boards 18) and the light guide plate 19 are arranged matches the Y-axis direction and an arrangement direction in which the optical member 15 (or the liquid crystal panel 11) and the light guide plate 19 are arranged matches the Z-axis direction. The arrangement directions are perpendicular to each other. The light guide plate 19 receives light emitted from the LEDs 17 in the Y-axis direction at the long-side end surfaces thereof, guides it therethrough, and directs it to the optical member 15 (the front-surface side, the light exit side). The light exits from the plate surface of the light guide plate 19. The light guide plate 19 is arranged in a middle portion of the bottom plate 14a of the chassis 14 with respect to the short-side direction. Accordingly, the light guide plate 19 is supported by the middle portion of the bottom plate 14a in the short-side direction from the rear-surface side. The light guide plate 19 is slightly larger than the optical member 15 and thus the peripheral edges thereof are located outside from the peripheral edges of the optical member 15. The peripheral edges of the light guide plate 19 are held down by the frame 16 described earlier (see FIG. 7).

A surface of the board surfaces of the light guide plate 19 on the front-surface side (a surface opposed to the liquid crystal panel 11 and the optical member 15) is a light exit surface 19a through which light exits toward the optical member 15 and the liquid crystal panel 11. Among peripheral edge surfaces of the light guide plate 19, a pair of long-side edge surfaces extending along the X-axis direction (the arrangement direction of the LEDs 17, the long-side direction of the LED board 18) is arranged so as to face the LEDs 17 (the LED boards 18) with specified distances therebetween. The long-side peripheral edge surfaces of the light guide plate 19 are the light entrance surfaces 19b through which light from the LEDs 17 enters. The first reflection sheet R1 is arranged on a front-surface side of a space generated between the LEDs 17 and the light entrance surface 19b. A second reflection sheet R2 is arranged on a rear-surface side of the space so as to cover the space with the first reflection sheet R1. The first and second reflections sheets R1, R2 are arranged to cover the space and sandwich the end portion of the light guide plate 19 closer to the LEDs 17 and the LEDs 17 therebetween. With this configuration, rays of light from the LEDs 17 are repeatedly reflected by the light reflection sheets R1 and R2. Accordingly, the rays of light effectively directed to the light entrance surfaces 19b. The light entrance surface 19b is parallel to a X-Z plane and substantially perpendicular to the light exit surface 19a. The arrangement direction in which the LEDs 17 and the light entrance surface 19b are arranged matches the Y-axis direction and parallel to the light exit surface 19a.

As illustrated in FIG. 7, among the plate surfaces of the light guide plate 19, on a surface 19c opposite to the light exit surface 19a, a third reflection sheet R3 is arranged over an entire area of the surface 19c. The third reflection sheet R3 directs the light being guided within the light guide plate 19 toward the front-surface side. In other words, the third reflection sheet R3 is sandwiched between the bottom plate 14a of the chassis 14 and the light guide plate 19. At least one of the light exit surface 19a and the opposite surface 19c of the light guide plate 19 and a surface of the third reflection sheet R3 has a scattering portion (not illustrated) configured to scatter light inside the light guide plate 19. The scattering portion may be formed by patterning with a specified in-plane distribution. With this configuration, the light exiting from the light exit surface 19a is controlled to have an even in-plane distribution.

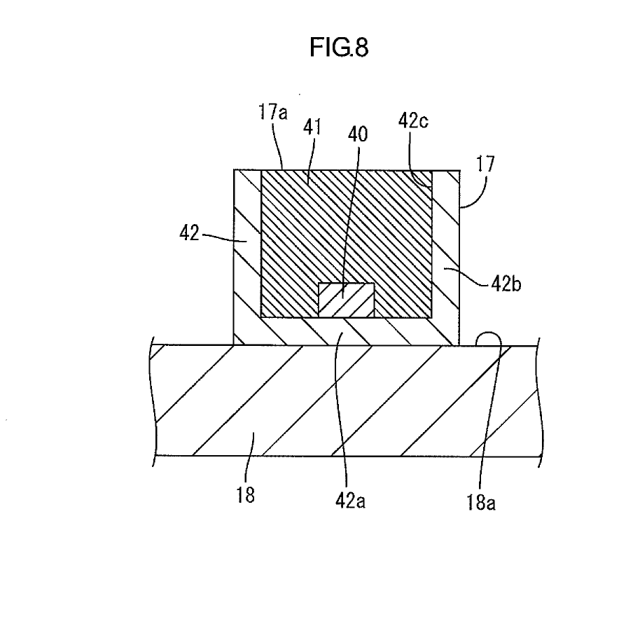

A configuration of the LED 17 will be described in detail. As illustrated in FIG. 8, the LED 17 includes an LED component (a LED chip, a light emission component) 40 that is a light emission source, an enclosure member (a transparent resin material) 41, and a casing (container) 42. The enclosure member 41 contains phosphor that emits light by excitation by light from the LED component 40. The LED component 40 is arranged in the casing 42 and the casing 42 is filled with the enclosure member 41. The light emitted from the light emission surface 17a of the LED 17 is almost white light as a whole. Components of the LED 17 will be described in detail with reference to FIG. 8.

The LED component 40 is a semiconductor made of InGaN-based material and emits light by application of forward voltage. The LED component 40 emits visible light and the emitted light has a main light emission wavelength in a blue wavelength range (approximately from 420 nm to 480 nm). Therefore, light emitted from the LED component 40 is used as a part of rays of light (white light) emitted from the LED 17 and also used as light that excites a phosphor. The LED component 40 is a blue LED component that emits light of a single color of blue. According to the present embodiment, a target main emission wavelength of the LED component 40 is set to 445 nm in its manufacturing process. However, each of the manufactured LED components 40 has a main emission wavelength that may vary from the target value (445 nm) within a predetermined value range, for example, ±5 nm due to manufacturing error. The LED component 40 is connected to the wiring pattern on the LED board 18 that is arranged outside the casing 42 via a lead frame (not illustrated).

The enclosure member 41 is made of a thermosetting resin material that is substantially transparent such as epoxy resin or silicone resin. The inner space of the casing 42 where the LED component 40 is arranged is filled with the enclosure member 41 in the manufacturing process of the LED 17 to enclose and protect the LED component 40 and the lead frame. Phosphors, which will be described later, are dispersed in and blended with the enclosure member 41. The enclosure member 41 functions as a dispersing medium (a binder) that holds a phosphor.

A phosphor is excited by light (blue light) emitted from the LED component 40 and emits light in a predetermined wavelength range. According to the present embodiment, the LED 17 includes two kinds of phosphors (a first phosphor and a second phosphor) each having different main emission wavelength in the emitted light (fluorescence). Specifically, the first phosphor is a green phosphor that is excited by light from the LED component 40 and emits light having a main emission wavelength in a green wavelength range (approximately 500 nm to 570 nm). The second phosphor is a red phosphor that is excited by light from the LED component 40 and emits light having a main emission wavelength in a red wavelength range (approximately 600 nm to 780 nm).

The LED 17 emits light entirely having a white color from the blue light (light having a blue component) emitted from the LED component 40, the green light (light having a green component) emitted from the green phosphor that is the first phosphor, and the red light (light having a red component) emitted from the red phosphor that is the second phosphor. White light may be obtained by using a yellow phosphor that emits yellow light instead of using the green phosphor and the red phosphor. However, according to the present embodiment with the above configuration, the light emission intensity of the green light and the red light increases and the exiting light is excellent in color rendering. The chromaticity of the emitted light (white light) from the LED 17 may vary according to the main emission wavelength value of the LED component 40 or an absolute value and a relative value of a blended amount (a contain amount) of each phosphor (the green phosphor and the red phosphor). A manufacturing error may necessarily occur in the main emission wavelength, a composition amount of each phosphor, and a composition ratio of each phosphor in the LED component 40. Accordingly, each of the manufactured LEDs 17 may emit light having chromaticity that may vary from the target chromaticity within a predetermined range.

An example of the green phosphor is β-SiAlON that is a kind of a Sialon-type phosphor. The Sialon-type phosphor is obtained by replacing a part of a silicone atom of silicon nitride with an aluminum atom and replacing a part of a nitrogen atom of silicon nitride with an oxygen atom. Namely, the Sialon-type phosphor is nitride. The Sialon-type phosphor that is nitride is excellent in light emission efficiency and durability compared to other phosphors made of sulfide or oxide. The term of “excellent in durability” means that brightness is less likely to be deteriorated with time even if the phosphor is exposed to exiting light having high energy from the LED component 40. The Sialon-type phosphor includes a rare-earth element (such as Tb, Yg, Ag) as an activator. β-SiAlON that is a kind of the Sialon-type phosphor is solid solution of 3-type silicon nitride crystal, and aluminum and oxygen. The general expression of the β-SiAlON is Si6-zAlzOzN8-z:Eu (z represents a dissolving amount) or (Si, Al)6(O, N)8:Eu. According to the present embodiment, β-SiAlON includes Eu (europium) as the activator, for example. This especially improves chromatic purity of the green emission light. According to the present embodiment, β-SiAlON that is a green phosphor has a main emission wavelength of approximately 540 nm in its emission light, for example.

CaAlSiN that is a kind of a CaAlSiN-based phosphor is used as the red phosphor. The CaAlSiN-based phosphor is a nitride containing calcium atom (Ca), aluminum atom (Al), silicon atom (Si), nitride atom (N). The CaAlSiN-based phosphor is excellent in the light emission efficiency and durability compared to other phosphors including sulfide or oxide, for example. The CaAlSiN-based phosphor includes a rare-earth element (such as Tb, Yg, Ag) as an activator. CaAlSiN that is a kind of the CaAlSiN-based phosphor includes Eu (europium) as the activator and expressed by a composition formula of CaAlSiN3:Eu. In the present embodiment, CaAlSiN that is a red phosphor has a main emission wavelength of approximately 650 nm in the emission light.

The casing 42 is made of synthetic resin (for example, polyamide resin) or ceramics that is white and has a surface excellent in light reflectivity. The casing 42 has a substantially box shape as a whole having an opening 42c on the light exit side (a light emission surface 17a side, an opposite side from the LED board 18). The casing 42 includes a bottom wall portion 42a and side wall portions 42b. The bottom wall portion 42a extends along amount surface of the LED board 18 and the side wall portions 42b extends upwardly from outer edges of the bottom wall portion 42a. The bottom wall portion 42a is formed in a square shape seen from the light exit side and the side wall portions 42b form a substantially square tubular shape following an outer peripheral edge of the bottom wall portion 42a. The LED component 40 is arranged on an inner surface (a bottom surface) of the bottom wall portion 42a of the casing 42. The lead frame is arranged to be through the side wall portions 42b. An end portion of the lead frame that is arranged in the casing 42 is connected to the LED component 40 and another end of the lead frame extending outside the casing 42 is connected to the wiring pattern arranged on the LED board 18.

As described before, the chromaticity of the emission light (white light) from the LED 17 may necessarily vary due to the manufacturing error. Therefore, if the manufactured LEDs 17 are arbitrarily mounted on the LED board 18, the light from the LEDs 17 arranged on the LED board 18 may have a predetermined tinge of color as a whole. When the light from the LEDs 17 on the LED board 18 is irradiated to the liquid crystal panel 11 and the light passes through the coloring portions 29R, 29G, 29B of the color filter 29 included in the liquid crystal panel 11, the transmission spectrum (refer to FIG. 9) influences the light. Accordingly, variation in the chromaticity caused in each of the LEDs 17 becomes greater and this adversely affects a display image. To deal with such a problem, the manufactured LEDs 17 may be classified based on the chromaticity of the emission light and only the LEDs 17 that are classified as ones that emit light having suitable chromaticity are selected and used. However, with such a classifying method, many of the LEDs 17 cannot be used. This lowers the yield ratio and increases a manufacturing cost.

As a result of the present inventors' enthusiastic study regarding the above problem, it is proved that the variation in the main emission wavelength in light from the LED component 40 has great influence on the chromaticity of an image displayed on the liquid crystal panel 11. Among the coloring portions 29R, 29G, 29B of the color filter 29 included in the liquid crystal panel 11, as illustrated in FIG. 9, the blue coloring portion 29B has a transmission spectrum represented by a graph formed in a mountain shape with low flatness (having less flat portion), as compared to the transmission spectrum of the other coloring portions 29R, 29G. The amount of transmission light in the blue coloring portion 29B is likely to change when the main emission wavelength in the blue light emitted from the LED component 40 varies. Accordingly, it may be inferred that the variation in the main emission wavelength in light from the LED component 40 has great influence on the chromaticity of a displayed image.

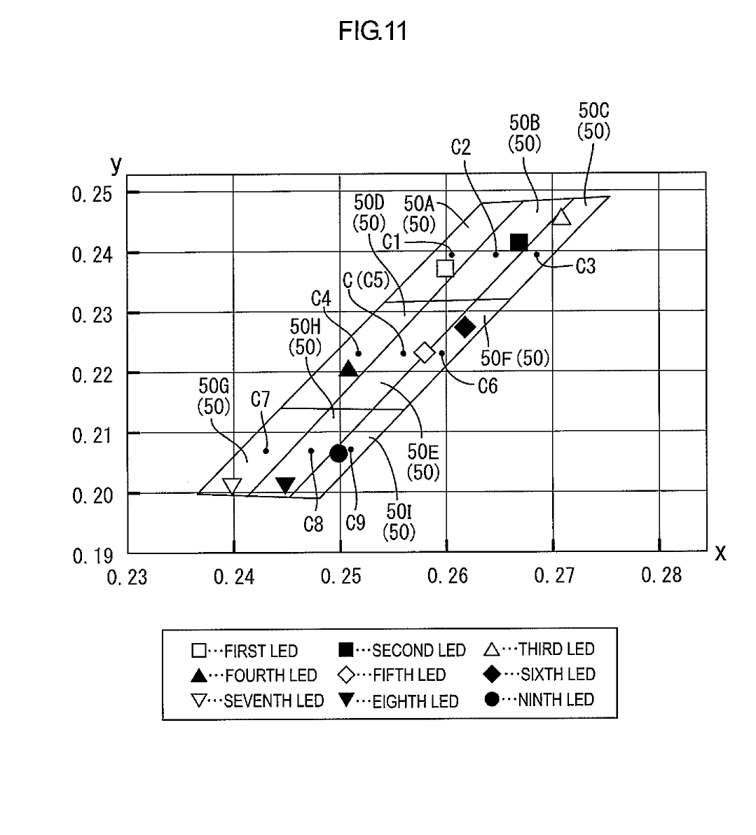

According to the present embodiment, the manufactured LEDs 17 are classified into three or more groups based on the chromaticity of its emission light such that each of the manufactured LEDs 17 is in one of three or more color regions 50 (FIG. 11) that are located in adjacent to each other in the CIE 1931 chromaticity diagram. Among the classified LEDs 17, two kinds of LEDs 17 in two different color regions 50 that are positioned symmetrically with respect to a center C of the three or more color regions 50 are mounted in adjacent to each other on the LED board 18. The three or more color regions 50 are positioned in adjacent to each other in the CIE 1931 chromaticity diagram. In the LED board 18 having such a configuration, the illumination light of the backlight unit 12 that is obtained by mixing the emission light of each LED 17 mounted on the LED board 18 has chromaticity that is effectively averaged. Therefore, variation is less likely to be caused in the chromaticity of an image displayed on the liquid crystal panel 11 and unevenness in coloring is less likely to occur. This achieves sufficient display quality. This reduces the amount of LEDs 17 that cannot be used for the liquid crystal display device 10 and increases the amount of LEDs 17 that can used. This improves the yield ratio relating the LEDs 17 and reduces the manufacturing cost. The unevenness in coloring is less likely to be caused in the image displayed on the liquid crystal panel 11. Accordingly, the process of independently adjusting white balance of an image displayed on the liquid crystal panel 11 that has been conventionally required is not necessary to be performed in the process of manufacturing the liquid crystal display device 10. This shortens takt time in the manufacturing process and this also reduces the manufacturing cost.

The LED board 18 having such a structure is manufactured in a following manufacturing method. In an LED classifying process (alight source classifying process), the LEDs 17 that are manufactured in an LED manufacturing process (a light source manufacturing process) are classified into three or more groups such that each of the LEDs 17 is in one of three or more color regions 50 that are positioned in adjacent to each other in the CIE 1931 chromaticity diagram according to the chromaticity of the emission light of each LED 17. The classified LEDs 17 are mounted on a substrate of the LED board 18 in an LED mount process (a light source mount process). In the LED mount process, the two kinds of LEDs 17 that are in two color regions 50 positioned symmetrically with respect to the center C of the three or more color regions 50 in the CIE 1931 chromaticity diagram are arranged in adjacent to each other on the LED board 18. Then, the manufactured LED board 18 is mounted to the backlight unit 12 in a mount process and the backlight unit 12 is integrally mounted to the liquid crystal panel 11 via the bezel 13. Thus, the liquid crystal display device 10 is manufactured.

The configuration and the manufacturing method according to the present embodiment are generally described and will be described in more details. As described before, the variation in the chromaticity of emission light (white light) from the LEDs 17 is necessarily caused due to the variation in the min emission wavelength of the LED component 40, the composition amount and the composition ratio of the phosphor caused due to the manufacturing error. Specifically, each of the manufactured LEDs 17 is controlled to emit light and the chromaticity of the emission light is measured. The measured results are plotted in the CIE 1931 chromaticity diagram. As a result of the plotting, the chromaticity of the emission light from the LED 17 has a predetermined distribution as illustrated in FIG. 11. The chromaticity distribution of the emission light from the LED 17 includes nine color regions 50A to 50I. The nine color regions 50A to 50I are defined in the CIE1931 chromaticity diagram by dividing an entire area of the chromaticity distribution into multiple regions in a substantially matrix (substantially rows and columns). Three color regions in a row direction (in a x-axis direction) and three in a column direction (in an inclined direction), and each of the chromaticity regions has a substantially equal area. Since the variation is caused in the main emission wavelength of the LED components, the entire area of the chromaticity distribution is divided into three in the row direction, that is, the chromaticity varies in the row direction. Since the variation is caused in the composition amount or the composition ratio, the entire area of the chromaticity distribution is divided into three in the column direction, that is, the chromaticity varies in the column direction. The entire area of the chromaticity distribution and each of the color regions 50A to 50I is formed in a substantially quadrilateral shape defined by line segments connecting four coordinate points. More specifically, the quadrilateral shape is a substantially parallelogram including a pair of sides that substantially match a lateral axis (an axis representing x values) and a pair of sides (inclined sides) that are inclined with respect to the lateral axis and a vertical axis (an axis representing y values). Each of the shape of the entire area of the chromaticity distribution and the color regions 50A to 50I has a substantially similar shape. A side located between each of the adjacent color regions 50A to 50I is included as a common side of the adjacent color regions 50A to 50I. The nine color regions 50A to 50I include a first color region 50A located at an upper left corner in FIG. 11, a second color region 50B located on the right side of the first color region 50A, a third color region 50C located on a right side of the second color region 50C, a fourth color region 50D located on a left end in a middle, a fifth color region 50E on the right side of the fourth color region 50D, a sixth color region 50F located on the right side of the fifth color region 50E, a seventh color region 50G located at a lower left corner, an eighth color region 50H located on the right side of the seventh color region 50G, and a ninth color region 50I located on the right side of the eighth color region 50H.

In classifying the LEDs 17 to be mounted on the LED board 18, the chromaticity of the emission light from each of the manufactured LEDs 17 is measured and it is determined in which one of the color regions 50A to 50I in FIG. 11 the obtained chromaticity is. A first LED 17A is in the first color region 50A, a second LED 17B is in the second color region 50B, a third LED 17C is in the third color region 50C, a fourth LED 17D is in the fourth color region 50D, a fifth LED 17E is in the fifth color region 50E, a sixth LED 17F is in the sixth color region 50F, a seventh LED 17G is in the seventh color region 50G, an eighth LED 17H is in the eighth color region 50H, and a ninth LED 17I is in the ninth color region 50I.

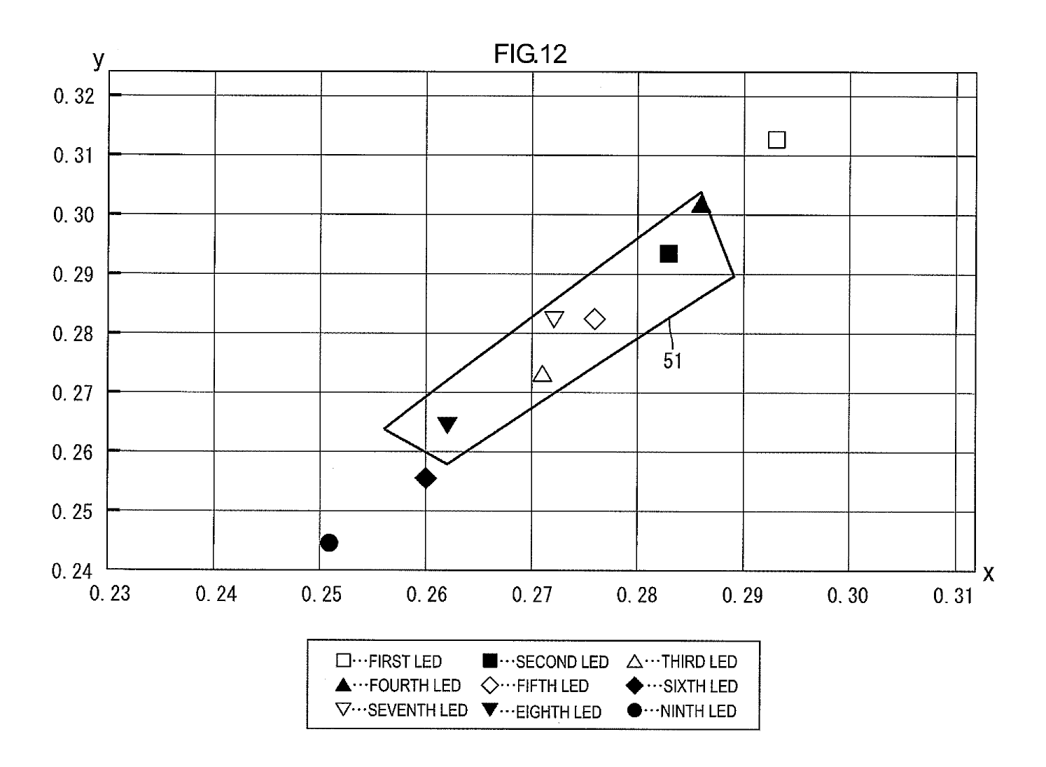

Each of the first LED 17A to the ninth LED 17I independently emits light and the chromaticity is obtained by transmitting each emission light through the liquid crystal panel 11 that displays white in an entire screen area and the obtained results are described in FIG. 12. As is in FIG. 12, when each of the first LED 17A to the ninth LED 17I is independently used, the chromaticity obtained by transmitting each emission light through the liquid crystal panel 11 varies greatly. In FIG. 12, a quadrilateral area illustrated by a solid line is a quality reference chromaticity region 51 where the chromaticity obtained with displaying white in the entire screen area of the liquid crystal panel 11 has a certain level of display quality. Among the first LED 17A to the ninth LED 17I, regarding the second LED 17B to the fifth LED 17E, the seventh LED 17G and the eighth LED 17H, the chromaticity obtained by transmitting the emission light through the liquid crystal panel 11 is within the quality reference chromaticity region 51. Regarding the first LED 17A, the sixth LED 17F, and the ninth LED 17I, the chromaticity obtained by transmitting the emission light through the liquid crystal panel 11 is outside the quality reference chromaticity region 51. The first LED 17A, the sixth LED 17F and the ninth LED 17I that have chromaticity outside of the quality reference chromaticity region 51 are excluded from the manufactured LEDs 17 and only the second LED 17B to the fifth LED 17E, the seventh LED 17G and the eighth LED 17H that have chromaticity within the quality reference chromaticity region 51 are used. This lowers the yield ratio regarding the LEDs 17 and increases the manufacturing cost.

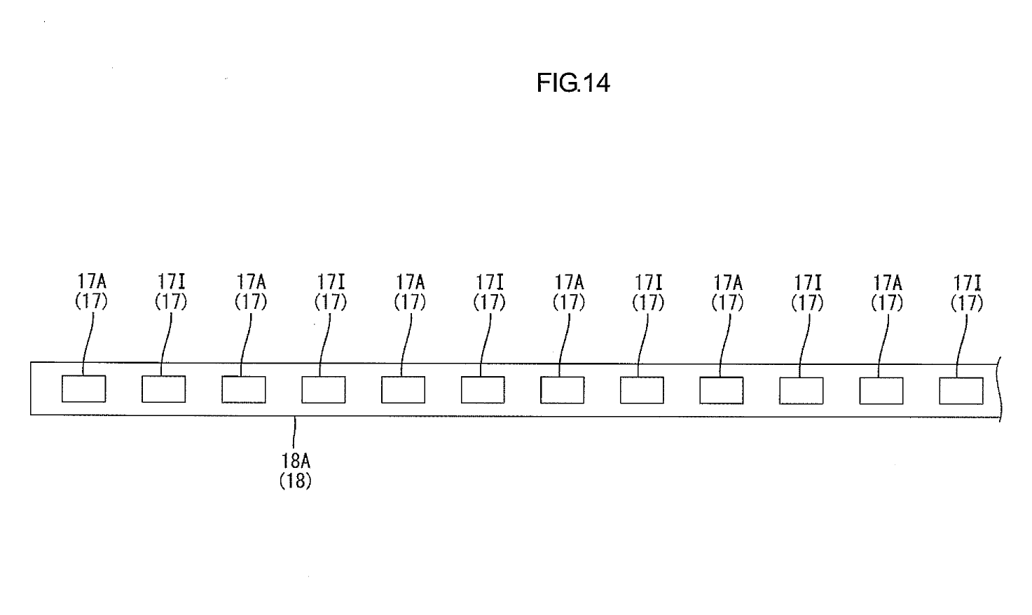

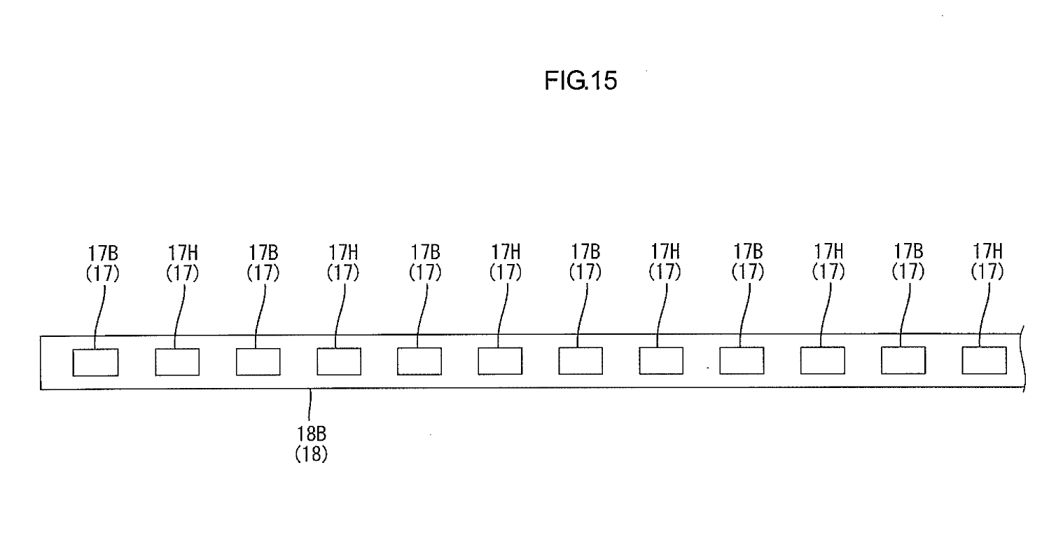

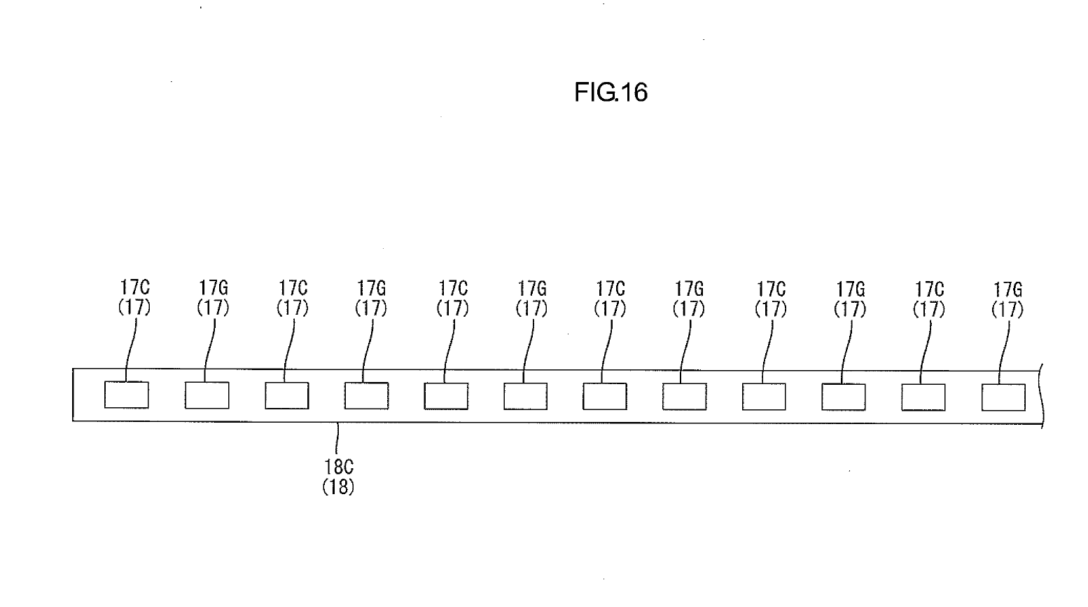

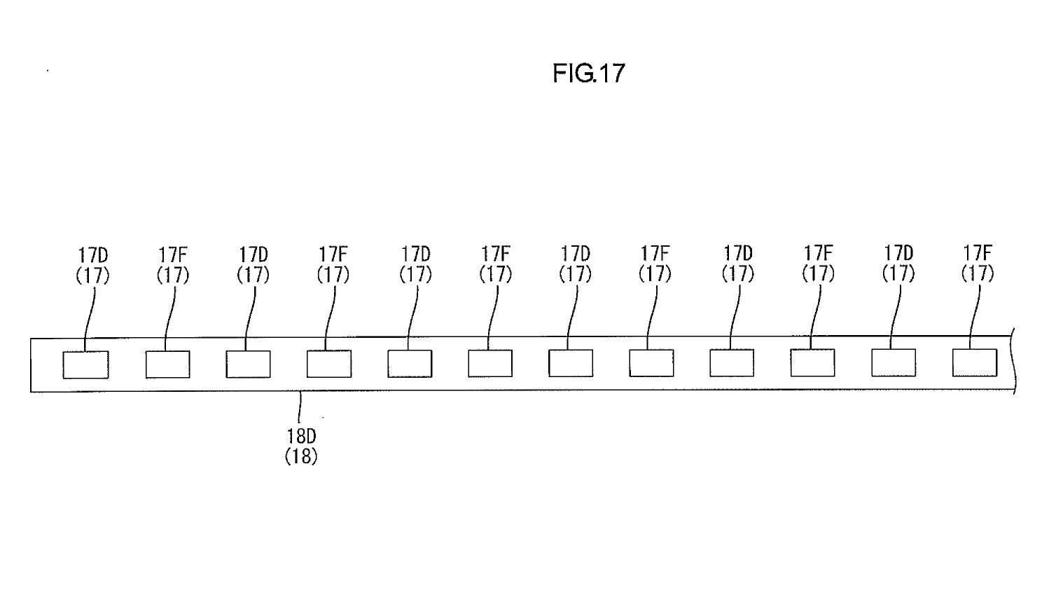

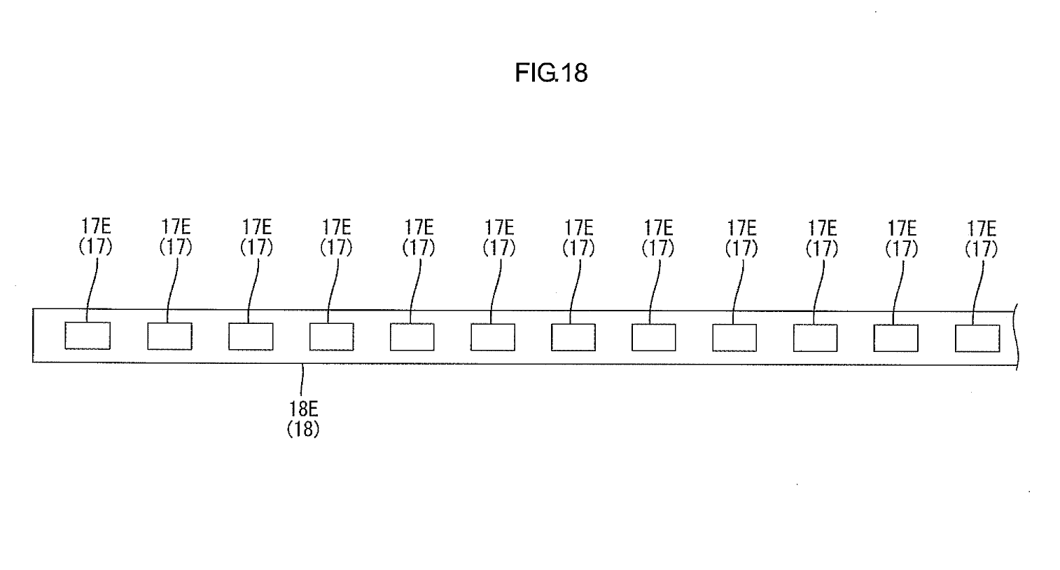

According to the present embodiment, the classified LEDs 17 are mounted on the LED board 18 according to a following rule. Among the LEDs 17A to 17I in the nine color regions 50A to 50I (FIG. 11) that are located in adjacent to each other in the CIE 1931 chromaticity diagram, two color regions that are symmetrical with respect to a center C of the nine color regions 50A to 50I are defined as a pair. Two LEDs 17 that are in the defined pair of color regions are arranged on the LED board 18 so as to be adjacent to each other. Examples of the defined pair of color regions include a pair of the first color region 50A and the ninth color region 50I, another pair of the second color region 50B and the eighth color region 50H, another pair of the third color region 50C and the seventh color region 50G, and another pair of the fourth color region 50D and the sixth color region 50F. Examples of the two LEDs 17 that are located in the defined pair of color regions include a pair of the first LED 17A and the ninth LED 17I, another pair of the second LED 17B and the eighth LED 17H, another pair of the third LED 17C and the seventh LED 17G, and another pair of the fourth LED 17D and the sixth LED 17F. Specifically, the first LED 17A and the ninth LED 17I are in the first color region 50A and the ninth color region 50I, respectively, that are symmetrical with respect to the center C. The first LEDs 17A and the ninth LEDs 17I are mounted on the same LED board 18 so as to be adjacent to each other as illustrated in FIG. 14, and thus a first LED board 18A is manufactured. Similarly, the second LED 17B and the eighth LED 17H are in the second color region 50B and the eighth color region 50H, respectively, that are symmetrical with respect to the center C. The second LEDs 17B and the eighth LEDs 17H are mounted on the same LED board 18 so as to be adjacent to each other as illustrated in FIG. 15, and thus a second LED board 18B is manufactured. The third LED 17C and the seventh LED 17G are in the third color region 50C and the seventh color region 50G, respectively, that are symmetrical with respect to the center C. The third LEDs 17C and the seventh LEDs 17G are mounted on the same LED board 18 so as to be adjacent to each other as illustrated in FIG. 16, and accordingly, a third LED board 18C is manufactured. The fourth LED 17D and the sixth LED 17F are in the fourth color region 50D and the sixth color region 50F, respectively, that are symmetrical with respect to the center C. The fourth LEDs 17D and the sixth LEDs 17F are mounted on the same LED board 18 so as to be adjacent to each other as illustrated in FIG. 17, and thus a fourth LED board 18D is manufactured. The fifth LED 17E that is in the fifth color region 50E including the center C is arranged in plural on the LED board as illustrated in FIG. 18, and thus a fifth LED board 18E is manufactured. The fifth LED board 18E does not include the LEDs 17A to 17D, 17F to 17I that are in the color regions 50A to 50D, 50F to 50I.

Among the first LED board 18A to the fifth LED board 18E, the first LED board 18A includes only the LEDs 17A and the LEDs 17I that are in the two color regions 50A, 50I, respectively, that are located diagonally among the nine color regions 50A to 50I that are arranged in a substantially matrix. The LEDs 17A and the LEDs 17I are mounted on the first LED board 18A alternately. Similarly, the third LED board 18C includes only the LEDs 17C and the LEDs 17G that are in the two color regions 50C, 50G, respectively, that are located diagonally. The LEDs 17C and the LEDs 17G are mounted on the third LED board 18C alternately.

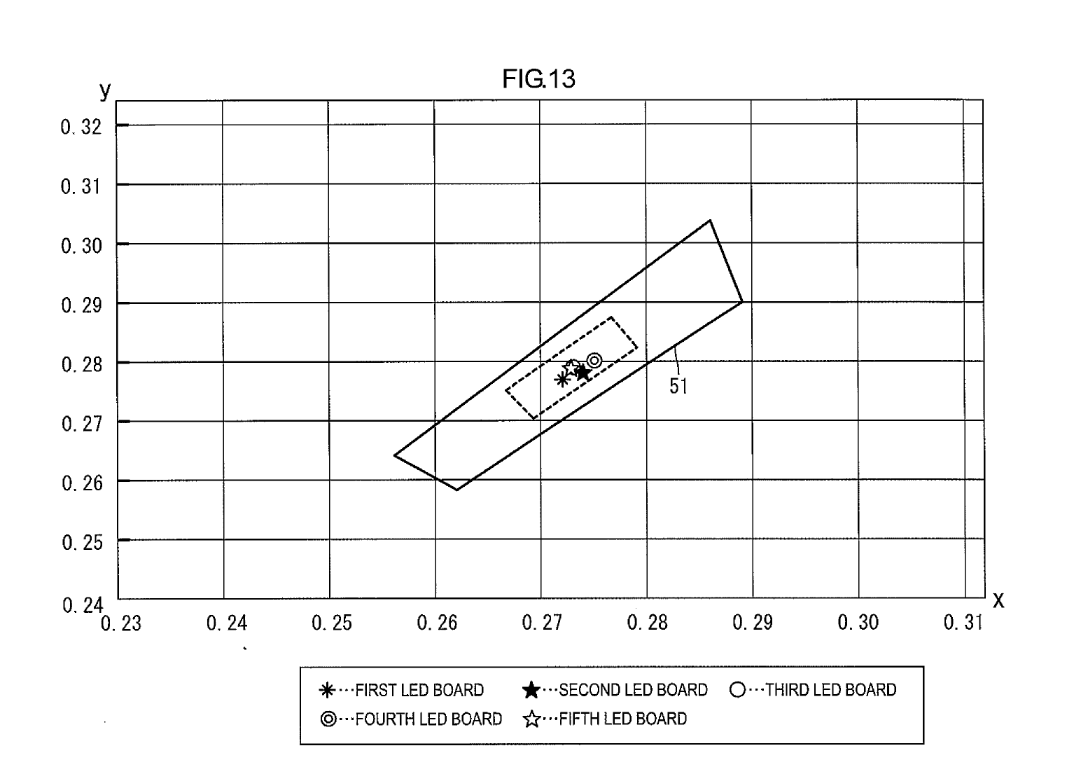

Each of the LEDs 17A to 17I that are mounted on the thus manufactured LED boards 18A to 18E is controlled to emit light separately for every LED board 18A to 18E. The chromaticity of light that is obtained by transmitting the emission light through the liquid crystal panel 11 that displays white in an entire screen area and the obtained results are illustrated in FIG. 13. The chromaticity of light emitted from the LEDs 17A to 17I is obtained for every LED board 18A to 18E by transmitting the emission light through the liquid crystal panel 11. All the chromaticity obtained for every LED board 18A to 18E is in a certain range (within a quadrilateral area represented by a dash line in FIG. 13). In FIG. 13, a quadrilateral area illustrated by a solid line is the quality reference chromaticity region 51 where the chromaticity obtained with displaying white in the entire screen area of the liquid crystal panel 11 has a certain level of display quality. All of the five plotting points according to the obtained results of the chromaticity are within the quality reference chromaticity region 51. Regarding the first LED board 18A to the fourth LED board 18D, the classified two kinds of the LEDs 17A to 17D, 17F to 17I are alternately arranged. Thus, light from the two kinds of LEDs 17A to 17D, 17F to 17I are mixed and the chromaticity of the two kinds of light is averaged. The fifth LED board 18E includes only one kind of the fifth LEDs 17E. The fifth LEDs 17E are manufactured as is designed and have almost target chromaticity, and the chromaticity obtained by transmitting the emission light through the liquid crystal panel 11 is quite close to the white reference chromaticity. Accordingly, any of the LED boards 18A to 18E is used for the backlight unit 12 and sufficient good display quality of the image displayed on the liquid crystal panel 11. The “white reference chromaticity” means that the x value and the y value are (0.272, 0.277) in the CIE 1931 chromaticity diagram.

The classified LEDs 17A to 17I may be mounted on the LED board 18 according to a following rule. The two kinds of LEDs 17 to be mounted on the LED board 18 are determined such that a length of a line segment connecting a center of the color region where one of the two LEDs 17 is and a center of the color region where the other one of the two LEDs 17 is longer than a length of any one of line segments connecting a center of any color regions 50 other than the two color regions and a center of each of the two color regions 50. Specifically, if the one of the two LEDs 17 to be mounted to the LED board 18 is the first LED 17A, the other one of the two LEDs 17 that is to be mounted in adjacent to the first LED 17A is determined as follows. First, a length of each line segment connecting the center C1 of the first color region 50A and each center C2 to C9 of other color regions 50B to 50I is obtained and compared to each other. One of the centers C2 to C9 of other color regions 50B to 50I that is included in the longest line segment is determined. That is, the ninth color region 50I including the center C9 is determined and the ninth LED 17I that is in the ninth color region 50I is determined to be the other one of the two LEDs 17 and make a pair with the first LED 17A. If the one of the two LEDs 17 to be mounted to the LED board 18 is the second LED 17B, the other one of the two LEDs 17 that is to be mounted in adjacent to the second LED 17B is determined according to the same processes as described before. The other one of the two LEDs 17 is determined to be the seventh LED 17G in the seventh color region 50G or the ninth LED 17I in the ninth color region 50I. However, according to the above rule, the seventh LED 17G is paired with the third LED 17C and the ninth LED 17I is paired with the first LED 17A. Therefore, the second LED 17B is paired with the eighth LED 17H that is in the eighth color region 50H that has a longest line segment next to the seventh color region 50G and the ninth color region 50I. The LED board 18 that is manufactured according to such a rule has a following configuration that: when a line is provided between the center of the color region where the first LED is and each of the center of one of at least two color regions other than the color region where the first LED is and the center of the other one of the at least two color regions, the second LED that is arranged in adjacent to the first LED (light source) is arranged in the color region such that the line becomes longest, and the at least two color regions are included in the at least three color regions 50.

As described before, the liquid crystal display device (the display device) 10 of the present embodiment includes the liquid crystal panel (the display panel) 11 that displays images, the backlight unit (the illumination unit) 12 that irradiates light to the liquid crystal panel 11, a plurality of LEDs (the light sources) 17 that are a light emission source of the backlight unit 12, and the LED board 18 included in the backlight unit 12 and on which the LEDs 17 are mounted. According to the chromaticity of emission light, the LEDs 17 are classified into at least three groups such that each of the LEDs 17 has the chromaticity of one of at least three color regions 50 that are located in adjacent to each other in the CIE 1931 chromaticity diagram. At least two color regions 50 are located symmetrically with respect to the center C of at least three color regions 50 in the CIE 1931 chromaticity diagram, and at least two LEDs 17 that are in the at least two color regions 50 are arranged in adjacent to each other on the LED board 18.

Thus, at least two color regions 50 are located symmetrically with respect to the center C of at least three color regions 50 in the CIE 1931 chromaticity diagram, and at least two LEDs 17 that are in the at least two color regions 50 are arranged in adjacent to each other on the LED board 18. Therefore, the light from the LEDs 17 mounted on the LED board 18 is mixed and the chromaticity of the illumination light from the backlight unit 12 is effectively averaged. Accordingly, unevenness in coloring of images displayed on the liquid crystal panel 11 is less likely to occur and sufficient display quality is obtained. This improves the yield ratio regarding the LEDs 17 and it is not necessary to adjust white balance of an image displayed on the liquid crystal panel 11 in the manufacturing process. This effectively reduces a cost for manufacturing the liquid crystal display device 10.

The LEDs 17 are classified into at least four groups such that the chromaticity of each LED 17 is in one of at least four color regions 50 that are positioned in a matrix in the CIE 1931 chromaticity diagram. Among at least four color regions 50 in the CIE chromaticity diagram, at least two color regions 50A, 50I (50C, 50G) are diagonally positioned. At least two LEDs 17A, 17I (17C, 17G) that are in the two diagonally positioned color regions are arranged in adjacent to each other on the LED board 18. Among at least four color regions 50 that are located in a matrix in the CIE chromaticity diagram, two color regions 50B, 50H (50D, 50F) are positioned symmetrically with respect to a point but not diagonally positioned. Compared to a configuration in which two LEDs 17B, 17H (17D, 17F) that are in the two color regions 50 are mounted on the LED board 18, the chromaticity of the illumination light from the backlight unit 12 that is obtained by mixing light from the LEDs 17A, 17I (17C, 17G) mounted on the LED board 18 is further effectively averaged. Accordingly, the unevenness in coloring of the image displayed on the liquid crystal panel 11 is further less likely to occur and display quality is further improved.

Among at least four color regions 50 in the CIE 1931 chromaticity diagram, at least two color regions 50A, 50I (50C, 50G) are diagonally positioned. At least two LEDs 17A, 17I (17C, 17G) that are in the two diagonally positioned color regions are arranged alternately and in adjacent to each other on the LED board 18. With such a configuration, compared to a configuration in which all of the four LEDs 17A, 17I, 17C, 17G that are in the diagonally positioned four color regions 50 are arranged on the LED board 18, the unevenness in color of the illumination light from the backlight unit 12 obtained by mixing the light from the LEDs 17A, 17I (17C, 17G) on the LED board 18 is further less likely to occur and the unevenness in coloring of an image displayed on the liquid crystal panel 11 is further less likely to occur. Further, the LED board 18 has a small variety of LEDs 17 and this effectively reduces a management cost regarding mounting of the LEDs 17.

At least two color regions 50A, 50I (50B, 50H, 50C, 50G, 50D, 50F) are positioned symmetrically with respect to the center C of at least three color regions in the CIE 1931 chromaticity diagram and two LEDs 17A, 17I (17B, 17H, 17C, 17G, 17D, 17F) that are in the at least two symmetrically positioned color regions are arranged alternately and in adjacent to each other on the LED board 18. With such a configuration, compared to a configuration in which four or more LEDs 17 in four or more color regions 50 that are positioned symmetrically with respect to a point, the unevenness in color of the illumination light from the backlight unit 12 obtained by mixing light from the LEDs 17A, 17I (17B, 17H, 17C, 17G, 17D, 17F) arranged on the LED board 18 is further less likely to occur and the unevenness in coloring of an image displayed on the liquid crystal panel 11 is further less likely to occur. Further, the LED board 18 has a small variety of LEDs 17A, 17I (17B, 17H, 17C, 17G, 17D, 17F) and this effectively reduces a management cost regarding mounting of the LEDs 17A, 17I (17B, 17H, 17C, 17G, 17D, 17F).

The LED board 18 is locally arranged on an end portion of the liquid crystal panel 11 of the backlight unit 12 and the LED boards 18 are arranged along the end portion of the liquid crystal panel 11. In such a backlight unit 12 of the edge-light type, compared to a direct-type backlight unit in which the LED board 18 and the LEDs 17 are arranged to face a plate surface of the liquid crystal panel 11, the interval between the LEDs 17 on the LED board 18 reduces. Therefore, light from the LEDs 17 that are in the different color regions 50 are easily mixed. Accordingly, unevenness in color of the illumination light from the backlight unit 12 is less likely to occur and unevenness in coloring in an image displayed on the liquid crystal panel 11 is further less likely to occur.

The backlight unit 12 includes the light guide plate 19 having the light entrance surface (an end surface) 19b that faces the LEDs 17 and the light exit surface (a plate surface) 19a that faces the plate surface of the liquid crystal panel 11. With such a configuration, light emitted from each LED 17 arranged on the LED board 18 enters the light entrance surface 19b of the light guide plate 19 and travels through the light guide plate 19. Thereafter, the light exits from the light exit surface 19a of the light guide plate 19 toward the plate surface of the liquid crystal panel 11. With the configuration in which the LEDs 17 that are in the different color regions 50 are arranged on the LED board 18, the light from the LEDs 17 is effectively mixed within the light guide plate 19 and exits therefrom toward the liquid crystal panel 11. Accordingly, unevenness in coloring of an image displayed on the liquid crystal panel 11 is further less likely to occur and this improves display quality.

The LED 17 includes the LED component (a light emitting component) 40 that emits visible light and a phosphor that is excited by the light from the LED component 40. The LED 17 including the LED component 40 that emits visible light uses the visible light as the exciting light for the phosphor and as the emission light from the LED 17. Therefore, if the variation in the main emission wavelength of each LED component 40 occurs in manufacturing the LEDs 17, the chromaticity of an image displayed on the liquid crystal panel 11 is likely to be varied because the visible light from the LED component 40 is irradiated to the liquid crystal panel 11 as the illumination light of the backlight unit 12 to display an image on the liquid crystal panel 11. Even if such LEDs 17 are used, at least two light sources in at least two color regions 50 that are positioned symmetrically with respect to the center C of at least three color regions in the CIE 1931 chromaticity diagram are arranged on the LED board 18, as described before, and therefore, the unevenness in coloring of the image displayed on the liquid crystal panel 11 is less likely to occur.

The LED 17 includes the LED component 40 that emits blue light and the phosphor that is excited by the blue light from the LED component 40 and emits light and emits white light as a whole. Accordingly, the LED 17 including the LED component that emits blue light is used to effectively provide white light as the whole emission light and a cost for manufacturing the LEDs 17 is reduced. This further reduces a cost for manufacturing the liquid crystal display device 10.

The light source is the LED 17. Accordingly, brightness is improved and power consumption is lowered.

A method of manufacturing the liquid crystal display device 10 of the present embodiment includes an LED classifying process (a light source classifying process), an LED mount process (a light source mount process), and a mount process. In the classifying process, the LEDs are classified into three groups based on the chromaticity of the emission light from each LED 17 such that each of the LEDs is in one of the three color regions 50 that are positioned in adjacent to each other in the CIE 1931 chromaticity diagram. In the LED mount process, at least two LEDs in at least two color regions 50 that are positioned symmetrically with respect to the center C of at least three color regions 50 in the CIE 1931 chromaticity diagram are arranged in adjacent to each other on the LED board 18. In the mount process, the LED board 18 is mounted to the backlight unit 12 and the backlight unit 12 is mounted to the liquid crystal panel 11.

Thus, in the LED classifying process, each of the LEDs 17 is classified to be in one of the at least three color regions 50 that are located in adjacent to each other in the CIE 1931 chromaticity diagram according to the chromaticity of the emission light from the LED 17. In the subsequent LED mount process, at least two LEDs 17 that are in at least two color regions 50 positioned symmetrically with respect to the center C of at least three color regions 50 in the CIE 1931 chromaticity diagram are arranged in adjacent to each other on the LED board 18. Thus manufactured LED board 18 is mounted to the backlight unit 12 in the mount process, and accordingly, the chromaticity of the illumination light from the backlight unit 12 that is obtained by mixing the light from the LEDs 17 is effectively averaged. Therefore, the unevenness in coloring of an image displayed on the liquid crystal panel 11 that is mounted to the backlight unit 12 is less likely to occur and sufficient display quality is obtained. This improves the yield ratio of the LEDs 17 and the white balance of the image displayed on the liquid crystal panel 11 is not necessary to be adjusted in the mount process. This effectively reduces a cost for manufacturing the liquid crystal display device 10.

### Second Embodiment

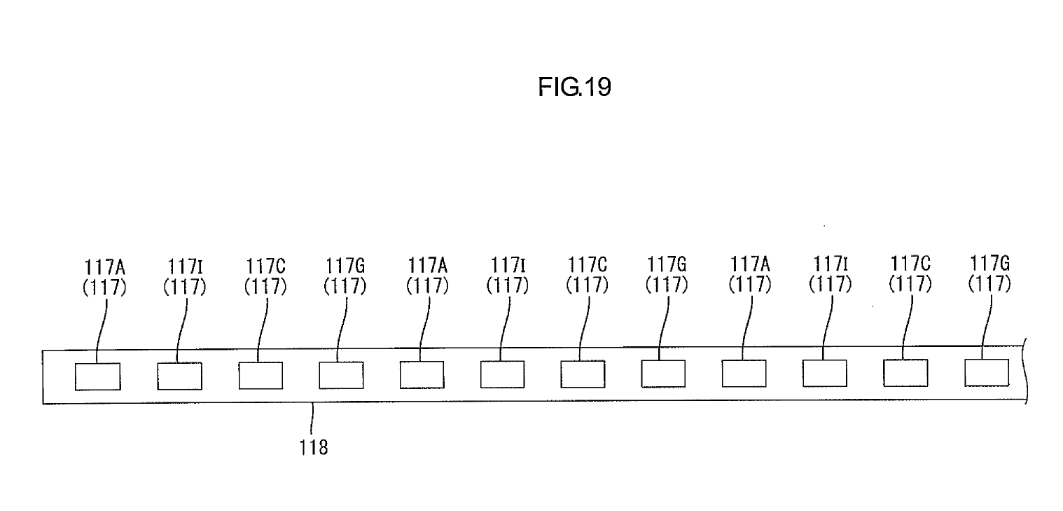

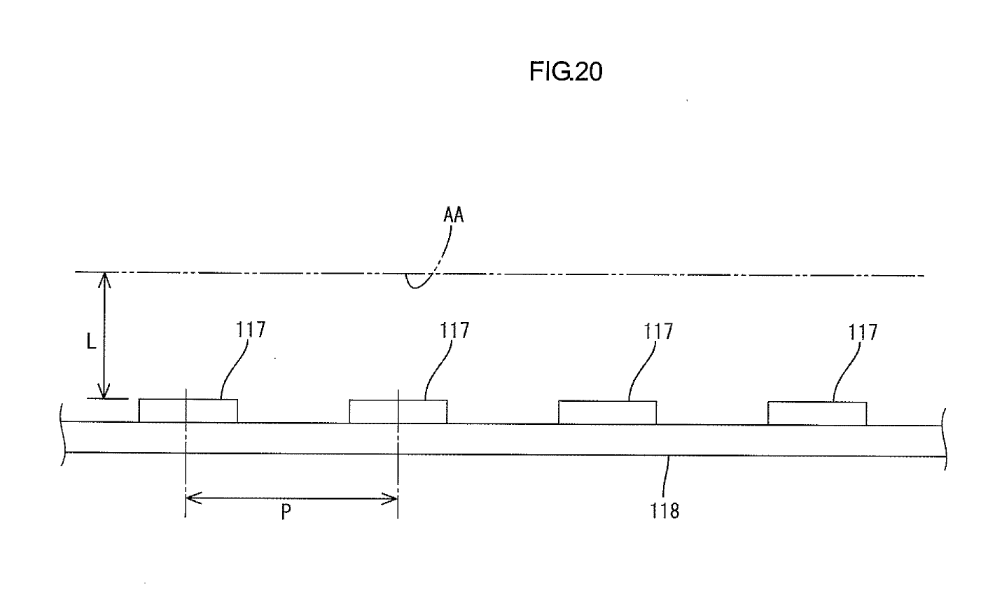

A second embodiment of the present invention will be described with reference to FIGS. 19 and 20. In the second embodiment, four kinds of LEDs 117 are mounted on an LED board 118. The configurations, the operations, and the effects similar to those in the first embodiment will not be described.

According to the present embodiment, the LEDs 117 are classified into nine groups such that each of the LEDs 117 is classified to be in one of the nine color regions 50 (refer to FIG. 11) in the CIE 1931 chromaticity diagram as described in the first embodiment, and among the classified LEDs 117, four kinds of LEDs 117 are mounted on the LED board 118. In selecting the four kinds of LEDs 117, the four kinds of LEDs 117 that are in the four color regions 50 positioned symmetrically with respect to the center C of the nine color regions 50 in the CIE 1931 chromaticity diagram are selected as is described in the first embodiment. Specifically, in the present embodiment, as illustrated in FIG. 19, first LEDs 117A having chromaticity of the first color region 50A, ninth LEDs 117I having chromaticity of the ninth color region 50I, third LEDs 117C having chromaticity of the third color region 50C, and seventh LEDs 117G having chromaticity of the seventh color region 50G are mounted alternately and in adjacent to each other on the LED board 118. The first color region 50A and the ninth color region 50I are positioned symmetrically with respect to the center C (diagonally). The third color region 50C and the seventh color region 50G are positioned symmetrically with respect to the center (diagonally).

The LED board 118 including the four kinds of LEDs 117 thereon easily causes the unevenness in color of the light from each LED 117 compared to the LED board 18 including one kind of LEDs 117 or two kinds of LEDs 117 thereon as described in the first embodiment. If an interval P between the LEDs 117 on the LED board 118 is a certain value or more as illustrated in FIG. 20, the light from each LED 117 is less likely to be mixed and this may make the unevenness in color to be more distinct. Therefore, such an LED board is unlikely to be used in the liquid crystal display device. If a distance L between the LEDs 117 and a display area AA surface of the liquid crystal panel is a certain value or less, the light from the LEDs 117 is less likely to be mixed and this may make the unevenness in color to be more distinct. The present inventors found that the display quality of an image displayed on the display area AA is sufficiently ensured if a ratio of the interval P and the distance L satisfies a following formula (2). If the ratio of the interval P and the distance L satisfies the formula (2), the light from the LEDs 117 is effectively mixed and the light is irradiated to the display area AA of the liquid crystal panel even with using the LED board 118 including the four kinds of LEDs 117 in the liquid crystal display device. Therefore, the LED board 118 of the present embodiment may be included in the liquid crystal display device having the configuration satisfying the formula (2).

[Formula 2]

L/P≧0.25 (2)

With a configuration in which the mirror-like finishing is performed on a light entrance surface of the light guide plate where the light from the LEDs 117 enters, compared to a configuration in which the surface roughening is performed on the light entrance surface, the light from the LEDs 117 is unlikely to be mixed. If a light guide plate where the surface roughening is performed on the light entrance surface is used, the LED board 118 including the four kinds of LEDs 117 is effectively used if the ratio of the interval P and the distance L satisfies a following formula (3).

[Formula 3]

L/P≧0.50 (3)

In the liquid crystal display device where the ratio of the interval P and the distance L satisfies a following formula (4), it is effective to improve the mixing rate of the light from the LEDs 117 with following methods, for example. The surface roughening is directly performed on the light entrance surface of the light guide plate which the light from the LEDs 117 enter or a light transmissive member (such as a transparent sheet) for which surface roughening is performed is adhered to the light entrance surface to effectively improve the mixing rate of the light from the LEDs 117. With such a configuration, compared to the liquid crystal display device that satisfies the formula (3), the distance L between the LED 117 and the surface of the display area AA of the liquid crystal panel reduces and this effectively reduces a whole frame size of the panel. The interval P between the LEDs 117 is increased and this effectively reduces the number of LEDs 117.

[Formula 4]

0.50≧L/P≧0.25 (4)

As is described before, according to the present embodiment, the LEDs 117 are classified into four kinds based on the chromaticity of the emission light of each LED 117 such that each of the LEDs 117 is in one of the four color regions 50 that are positioned in a matrix in the CIE 1931 chromaticity diagram. The liquid crystal panel includes a display area AA where an image is displayed and a non-display area AA that surrounds the display area AA. If the ratio of the distance L between the LEDs 117 on the LED board 118 and a surface of the display area and the interval P between the LEDs 117 on the LED board 118 satisfies the formula (2), at least four LEDs 117 that are in at least four color regions 50 positioned symmetrically with respect to the center C of at least four color regions 50 in the CIE 1931 chromaticity diagram are arranged in adjacent to each other on the LED board 118.

As the distance L between the LEDs 117 and the surface of the display area AA increases, the mixing rate of the light from the LEDs 117 increases and difference in the chromaticity of each LED 117 is unlikely to be recognized. As the distance L decreases, the mixing rate of the light lowers and the difference in the chromaticity of each LED 117 is likely to be recognized. As the interval P between the LEDs 117 increases, the light from the LEDs 117 is unlikely to be mixed. As the interval P decreases, the light from the LEDs 117 is likely to be mixed. With considering the above, if the ratio of the distance L and the interval P satisfies the formula (2), compared to the LED board 18 on which only two kinds of LEDs 17 in the two color regions 50 that are positioned symmetrically with respect to a point, the LED board -118 that includes at least four LEDs 117 that are likely to relatively cause unevenness in color is effectively used. The LED board 118 having such a configuration is used and accordingly, various kinds of LEDs 117 can be used. This improves the yield ratio of the LEDs 117 and reduces a cost.

### Third Embodiment

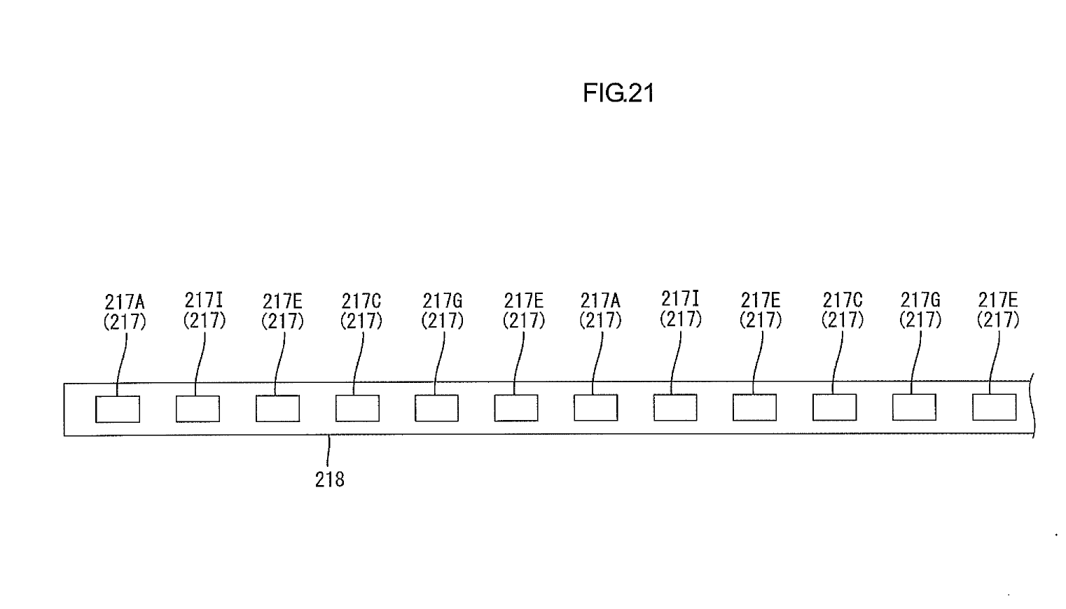

A third embodiment of the present invention will be described with reference to FIG. 21. In the third embodiment, five kinds of LEDs 217 are mounted on an LED board 218. The configurations, the operations, and the effects similar to those in the first and second embodiments will not be described.

According to the present embodiment, the LEDs 217 are classified into nine groups such that each of the LEDs 217 is in one of the nine color regions 50 (refer to FIG. 11) in the CIE 1981 chromaticity diagram as is in the first embodiment, and five kinds of the classified LEDs 217 are selected and mounted on the LED board 218. The five kinds of LEDs 217 include first LEDs 217A, third LEDs 217 C, seventh LEDs 217G, ninth LEDs 217I, that are selected in the second embodiment, and fifth LEDs 217E. The LEDs 217 are arranged on the LED board 218 in a following order. Two LEDs 217 in the two color regions 50 that are positioned symmetrically with respect to the center C of the nine color regions in the CIE 1931 chromaticity diagram form a pair of LEDs 217 and the two LEDs 217 included in the pair are arranged in adjacent to each other on the LED board 218. The LED 217 that is in the color region 50 including the center C is arranged between the two pairs of LEDs 217. Specifically, the LEDs 217 are arranged sequentially from a first LED 217A, a ninth LED 218I, a fifth LED 217E, a third LED 217C, a seventh LED 217G, a fifth Led 217E, a first LED 217A . . . in this order. Such an LED board 218 is effectively used in a liquid crystal display device that satisfies any one of the formulae (2) to (4) described in the second embodiment.

As described before, according to the present embodiment, the five kinds of LEDs 217 include ones that have the chromaticity of the emission light in the color region 50E including the center C of at least three color regions 50 in the CIE 1931 chromaticity diagram. The LEDs 217E that are in the color region 50E including the center C of the at least three color regions 50 are mounted on the LED board 218. Accordingly, at least two LEDs 217 that are in at least two color regions 50 positioned symmetrically with respect to the center C of at least three color regions 50 in the CIE 1931 chromaticity diagram and also the LEDs 217 that are in the color region 50 including the center C are arranged on the LED board 218. Therefore, the chromaticity of the illumination light from the backlight unit is further effectively averaged. The unevenness in coloring of an image displayed on the liquid crystal panel is less likely to occur and high display quality is obtained.

### Fourth Embodiment

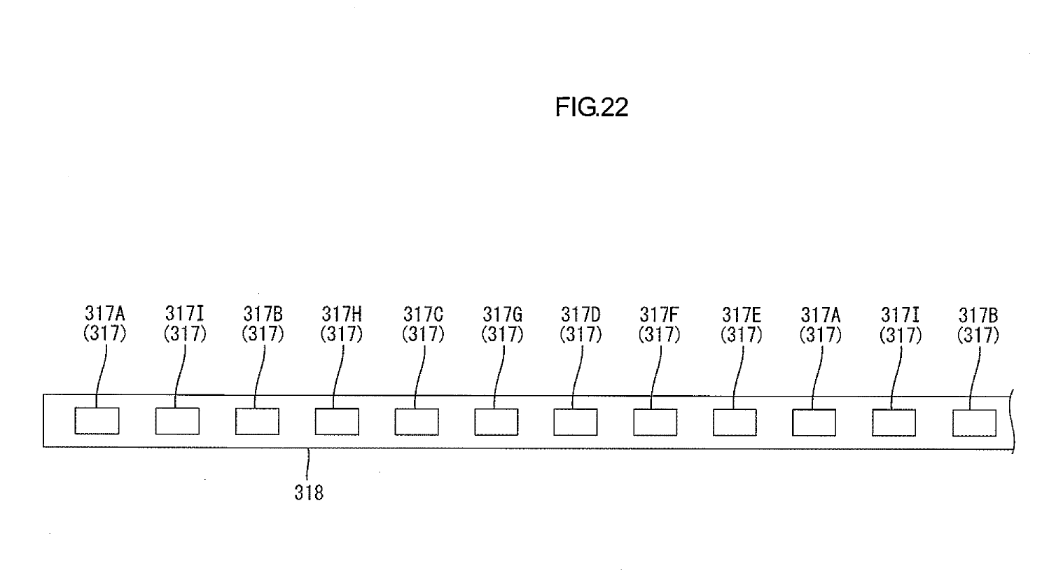

A fourth embodiment of the present invention will be described with reference to FIG. 22. In the fourth embodiment, all of the nine kinds of LEDs 317 are mounted on an LED board 318. The configurations, the operations, and the effects similar to those in the first and second embodiments will not be described.

According to the present embodiment, the LEDs 317 are classified into nine groups such that each of the LEDs 317 is in one of the nine color regions 50 (refer to FIG. 11) in the CIE 1931 chromaticity diagram as is in the first embodiment. In the present embodiment, all of the nine kinds of LEDs 317 are mounted on the LED board 318. The LEDs 317 are arranged on the LED board 318 in a following order. Two LEDs 317 that are in two color regions 50 that are positioned symmetrically with respect to the center C of the nine color regions 50 in the CIE 1931 chromaticity diagram forms a pair of LEDs 317. Two LEDs 317 included in a pair are arranged in adjacent to each other on the LED board 318. Four pairs of LEDs 317 are arranged in adjacent to each other and the LED 317 in the color region 50 including the center C is arranged in adjacent to the four pairs of LEDs 317. Specifically, the LEDs 317 are arranged sequentially from a first LED 317A, a ninth LED 317I, a second LED 317B, an eighth LED 317H, a third LED 317C, a seventh LED 317G, a fourth Led 317D, a sixth LED 317F, a fifth LED 317E, a first LED 317A . . . on the LED board 318 in this order. Such an LED board 318 is effectively used in a liquid crystal display device that satisfies any one of the formulae (2) to (4) described in the second embodiment.

### Fifth Embodiment

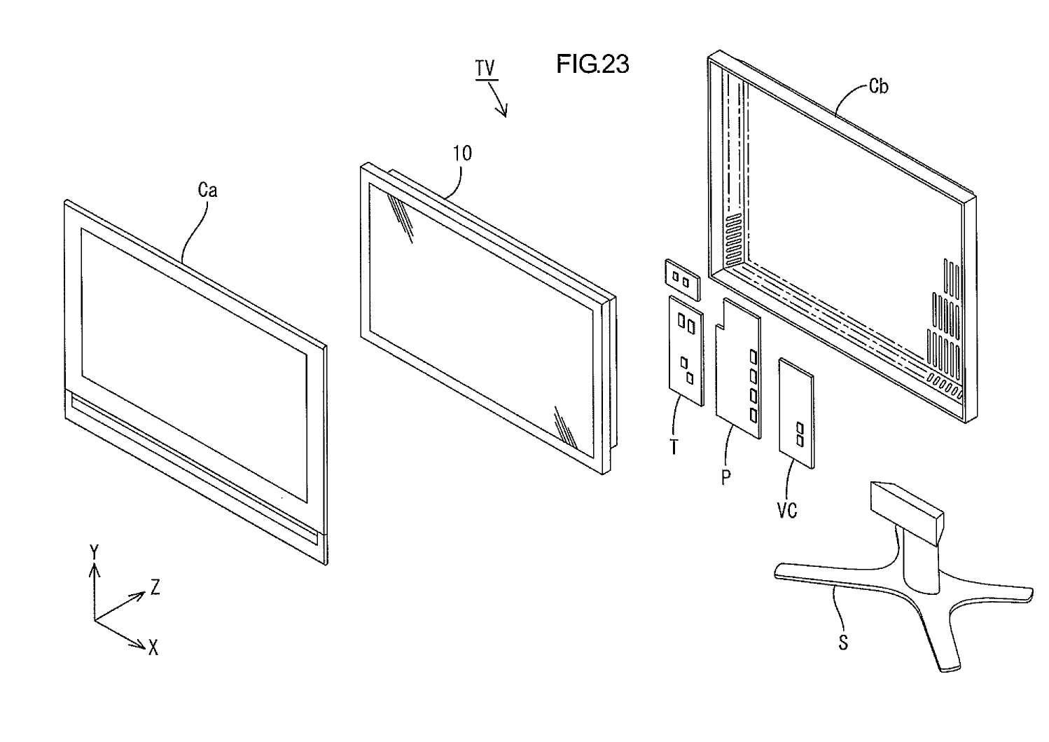

A fifth embodiment of the present invention will be described with reference to FIGS. 23 to 26. In the fifth embodiment, a liquid crystal panel 411 includes a four-color color filter 429. The configuration, the operations, and the effects similar to those in the first embodiment will not be described.

According to the present embodiment, as illustrated in FIG. 23, a television device TV and a liquid crystal display device 410 includes an image conversion circuit board VC that converts television image signals output from the tuner T into image signals for the liquid crystal display device 410. More in details, the image conversion circuit board VC converts the television image signals into image signals of each color of blue, green, red, and yellow and the generated image signal of each color is output to a display control circuit board that is connected to a liquid crystal panel.

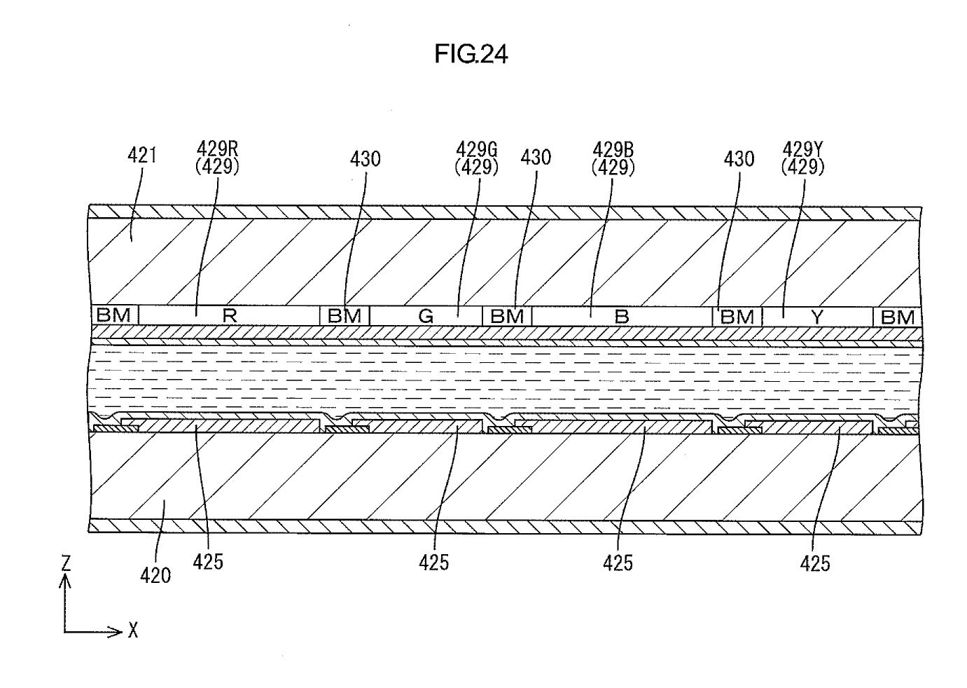

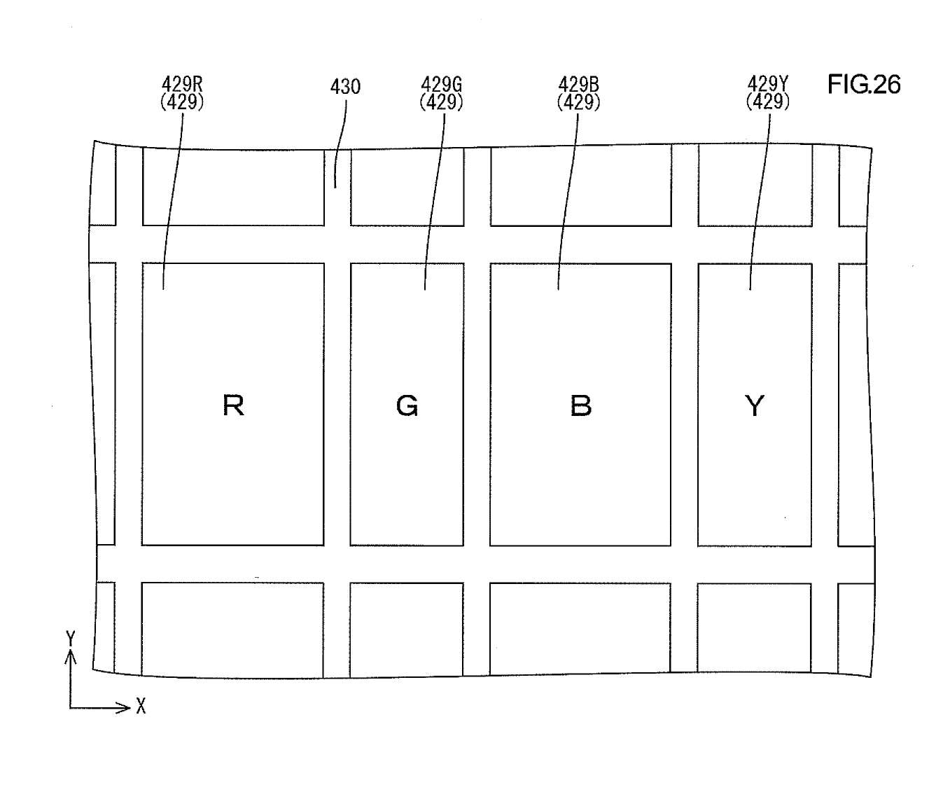

As illustrated in FIGS. 24 and 26, a color filter 429 is arranged on an inner surface of a CF board 421 included in a liquid crystal panel 411, that is a surface of the CF board 421 on a liquid crystal layer 422 side (a surface that faces an array substrate 420). The color filter 429 includes multiple color portions R, G, B, Y that are arranged in a matrix (columns and rows) corresponding to each pixel of the array substrate 420. The color filter 429 of the present embodiment includes a red color portion 429R, a green color portion 429G, a blue color portion 429B that are three primary colors, and a yellow color portion 429Y. Each of the color portions 429R, 429G, 429B, 429Y selectively transmits light of a corresponding color (a corresponding wavelength). Each of the color portions 429R, 429G, 429B, 429Y is formed in an elongated quadrilateral (rectangular) shape such that its long side matches the Y-axis direction and its short side matches the X-axis direction similar to pixel electrodes 425. A light blocking portion 430 is arranged between the coloring portions 429R, 429G, 429B, 429Y to prevent the colors from being mixed. The light blocking portion 430 is formed in a matrix.

Arrangement and a size of each of the coloring portions 429R, 429G, 429B, 429Y included in the color filter 429 will be described in details. As illustrated in FIG. 26, the color portions 429R, 429G, 429B, 429Y are arranged in rows and columns. The X-axis direction corresponds to a row direction and the Y-axis direction corresponds to a column direction. A size of each color portion 429R, 429G, 429B, 429Y in the column direction (the Y-axis direction) is same. However, a size of each color portion 429R, 429G, 429B, 429Y in the row direction (the X-axis direction) is different from each other. Specifically, the coloring portions 429R, 429G, 429B, 429Y are arranged sequentially from the red coloring portion 429R, the green coloring portion 429G, the blue coloring portion 429B, the yellow coloring portion 429Y in this order from the left side in FIG. 26 along the row direction. A size of the red coloring portion 429R and the blue coloring portion 429B in the row direction is relatively greater than a size of the yellow coloring portion 429Y and the green coloring portion 429G in the row direction. Namely, the coloring portions 429R, 429B that have relatively great size in the row direction and the coloring portions 429G, 429Y that have relatively small size in the row direction are arranged alternately in a repetitive manner. Accordingly, an area of each of the red coloring portion 429R and the blue coloring portion 429B is greater than an area of each of the green coloring portion 429G and the yellow coloring portion 429Y. The area of the blue coloring portion 429B and that of the red coloring portion 429R are equal to each other. Similarly, the area of the green coloring portion 429G and that of the yellow coloring portion 429Y are equal to each other. In FIGS. 24 and 26, the area of each of the red coloring portion 429R and the blue coloring portion 429B is approximately 1.6 times of the area of each of the yellow coloring portion 429Y and the green coloring portion 429G.

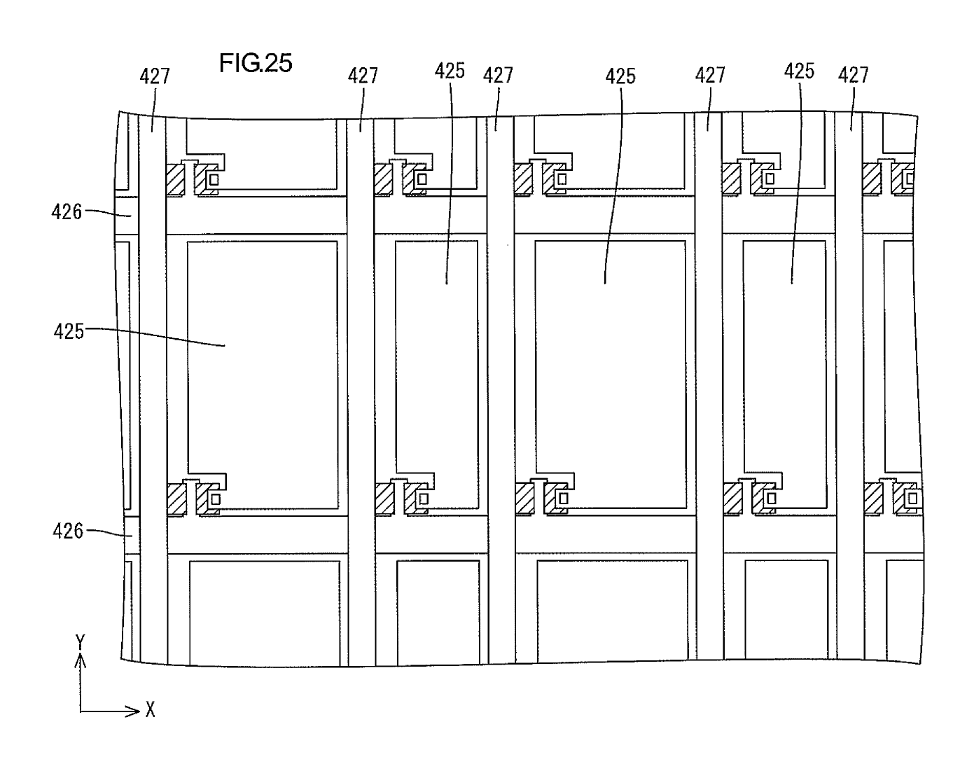

According to such a configuration of the color filter 429, a size of the pixel electrodes 425 in the row direction (the X-axis direction) differs in each row on the array substrate 420, as illustrated in FIG. 25. A row-direction size and an area of the pixel electrode 425 that overlaps each of the red coloring portion 429R and the blue coloring portion 429B is relatively greater than a row-direction size and an area of the pixel electrode 425 that overlaps each of the yellow coloring portion 429 and the green coloring portions 429G. The gate lines 426 are arranged at equal intervals and the source lines 427 are at two different intervals according to the row-direction size of the pixel electrodes 425. In this embodiment, auxiliary capacity lines are not illustrated.

Thus structured liquid crystal panel 411 is activated by input of signals from a display control circuit board (not illustrated). The television image signals output from the tuner T are converted into image signals of each color of blue, green, red, and yellow by a circuit on the image conversion circuit board VC illustrated in FIG. 23 and the image signals of each color is generated. The generated image signals are input to the display control circuit board. Accordingly, the amount of transmission light that transmits through each of the coloring portions 429R, 429G, 429B, 429Y is controlled effectively in the liquid crystal panel 411. The color filter 429 of the liquid crystal panel 411 includes the yellow coloring portion 429Y in addition to the coloring portions 429R, 429G, 429B of the three primary colors. Therefore, the color gamut of a display image displayed with the transmitted light expands and the image can be displayed with high color reproducibility. The light passed through the yellow color portion has a wavelength close to a visible peak. Namely, human beings tend to perceive the light as bright light even though the light is emitted with low energy. Accordingly, sufficient brightness still can be achieved with reduced output of the LEDs included in the backlight unit. This reduces the power consumption of the LEDs and improves environmental efficiency.

When the four-color-type liquid crystal panel 411 described above is used, an overall color of the display images displayed on the liquid crystal panel 411 tends to be yellowish. To solve this problem, in the backlight unit of this embodiment, the chromaticity of the emission light from the LED is adjusted to be bluish. Blue is a complementary color of yellow. Accordingly, the chromaticity of the display image is corrected. The LEDs included in the backlight unit have main emission wavelength that is in the wavelength region of blue light and have greatest emission intensity of the light in the wavelength region of blue light, as described before.

However, if the chromaticity of the emission light from the LEDs is adjusted to be bluish to increase the emission intensity of the blue light, following problem may be caused. The blue light is used as the emission light from the LED components and also as the transmitted light transmitted through the blue coloring portion 429B that has lowest flatness of the transmission spectrum (refer to FIG. 9) among the coloring portions 429R, 429G, 429B, 429Y included in the color filter 429. Therefore, if the main emission wavelength of the LED components varies due to the manufacturing error, the chromaticity of the image displayed on the liquid crystal panel 411 tends to vary greatly. As is described in the first embodiment, the classified LEDs are arranged on the LED board such that two kinds of LEDs that are in two color regions positioned symmetrically with respect to a center of three or more adjacent color regions in the CIE 1931 chromaticity diagram. With such a configuration, the unevenness in coloring of the display image displayed on the liquid crystal panel 411 is less likely to occur.

According to this embodiment, the liquid crystal panel 411 includes the color filter 429 including the coloring portion 429R in red, the coloring portion 429G in green, the coloring portion 429B in blue, and the coloring portion 429Y in yellow. With such a configuration, the color filter 429 includes the yellow coloring portion 429Y in addition to the coloring portions 429R, 429G, 429B of the primary three colors of blue, green, and red. This expands the color reproduction range that can be perceived by human beings, that is, the chromaticity, and the color reproducibility of colors of objects existing in nature is improved. This improves display quality. Among the coloring portions 429R, 429G, 429B, 429Y included in the color filter 429, the light passed through the yellow color portion 429Y has a wavelength close to a visible peak. Therefore, human beings tend to perceive the light as bright light having great brightness even though the light is emitted with low energy. Accordingly, sufficient brightness still can be achieved with reduced output of the LEDs. This reduces the power consumption of the LEDs and improves environmental efficiency. In the liquid crystal panel 411 including the color filter 429 having the yellow coloring portion 429Y, light exiting from the liquid crystal panel 411 or an overall color of the display images displayed on the liquid crystal panel 411 tend to be yellowish. To solve this problem, the chromaticity of the emission light from the LEDs included in the backlight unit is adjusted to be bluish. Blue is a complementary color of yellow. However, if the main emission wavelength of each of the LED components varies in manufacturing the LEDs, the chromaticity of the display images displayed on the liquid crystal panel 411 is more likely to be varied. According to the present embodiment, two kinds of LEDs in at least two color regions positioned symmetrically with respect to a center of at least three adjacent color regions in the CIE 1931 chromaticity diagram are arranged on the LED board. With such a configuration, the unevenness in coloring of the display image displayed on the liquid crystal panel 411 is less likely to occur.

### Sixth Embodiment

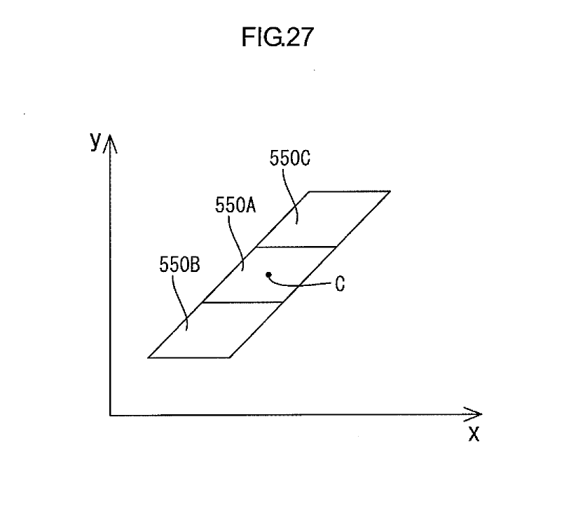

A sixth embodiment of the present invention will be explained with reference to FIG. 27. In the sixth embodiment, the LEDs are classified into three groups. The configurations, the operations, and the effects similar to those of the first embodiment will not be described.

In this embodiment, the LEDs are classified into three color regions 550A to 550C that are adjacent to each other in the CIE 1931 chromaticity diagram according to the chromaticity of emission light from each of the LEDs. The three color regions 550A to 550C are positioned obliquely. A middle one is a first color region 550A, one that is positioned on a lower side with respect to the first color region 550A is a second color region 550B, and one that is positioned on an upper side with respect to the first color region 550A is a third color region 550C. The LEDs are arranged on the LED board such that the LED that is in the second color region 550B and the LED that is in the third color region 550C are in adjacent to each other. The second color region 550B and the third color region 550C are positioned symmetrically with respect to a center C of the three color regions 550A to 550C. Only the LEDs that are in the first color region 550A may be mounted on the LED board.

### Seventh Embodiment

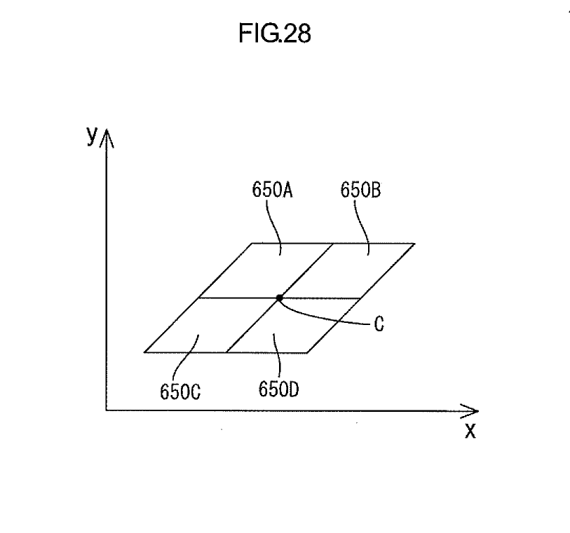

A seventh embodiment of the present invention will be described with reference to FIG. 28. In the seventh embodiment, the LEDs are classified into four groups. The configurations, the operations, and the effects similar to those of the first embodiment will not be described.

In this embodiment, the LEDs are classified into four groups based on the chromaticity of the emission light from the LEDs such that each of the LEDs is in one of four color regions 650A to 650D that are adjacent to each other in the CIE 1931 chromaticity diagram. The four color regions 650A to 650D are defined by dividing an entire chromaticity distribution area into a plurality of regions in a substantially matrix. One that is on the upper left side in FIG. 28 is a first color region 650A, one that is on the right side of the first color region 650A is a second color region 650B, one that is on the lower left side is a third color region 650C, and one that is on the right side of the third color region 650C is a fourth color region 650D. The LEDs are arranged on the LED board such that the LEDs in the first color region 650A (the second color region 650B) and the fourth color region 650D (the third color region 650C) are adjacent to each other. The first color region 650A (the second color region 650B) and the fourth color region 650D (the third color region 650C) are positioned symmetrically with respect to a center of the four color regions 650A to 650D.

### Eighth Embodiment

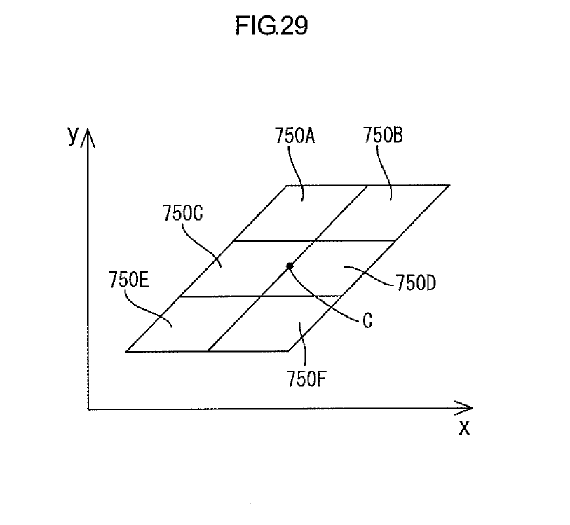

An eight embodiment of the present invention will be explained with reference to FIG. 29. In the eighth embodiment, the LEDs are classified into six groups. The configurations, the operations, and the effects similar to those of the first embodiment will not be described.

In this embodiment, the LEDs are classified into six groups based on the chromaticity of emission light from each of the LEDs such that each of the LEDs is in one of six color regions 750A to 750F that are adjacent to each other in the CIE 1931 chromaticity diagram. The six color regions 750A to 750D are defined by dividing an entire chromaticity distribution area into a substantially matrix. In FIG. 29, one that is on the upper left side is a first color region 750A, one that is on the right side of the first color region 750A is a second color region 750B, one that is on the middle left end side is a third color region 750C, one that is on the right side of the third color region 750C is a fourth color region 750D, one that is on the lower left side is a fifth color region 750E, and one that is on the right side of the fifth color region 750E is a sixth color region 750F. The LEDs are arranged on the LED board such that the LEDs in the first color region 750A (the second color region 750B, the third color region 750C) and the sixth color region 750F (the fifth color region 750E, the fourth color region 750D) are adjacent to each other. The first color region 750A (the second color region 750B, the third color region 750C) and the sixth color region 750F (the fifth color region 750E, the fourth color region 750D) are positioned symmetrically with respect to a center of the six color regions 750A to 750F.

### Ninth Embodiment

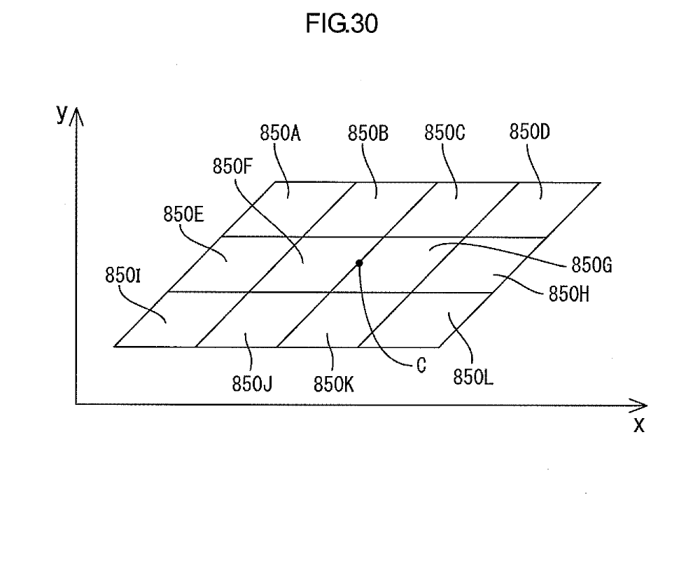

A ninth embodiment of the present invention will be described with reference to FIG. 30. In the ninth embodiment, the LEDs are classified into twelve groups. The configurations, the operations, and the effects similar to those of the first embodiment will not be described.

In this embodiment, the LEDs are classified into twelve groups based on the chromaticity of each of the LEDs such that each of the LEDs is in one of twelve color regions 850A to 850L that are adjacent to each other in the CIE 1931 chromaticity diagram. The twelve color regions 850A to 850L are defined by dividing an entire chromaticity distribution area into twelve regions in a substantially matrix. In FIG. 30, one that is on the upper left side is a first color region 850A, and a second color region 850B, a third color region 850C, a fourth color region 850D are located in this order rightward from the first color region 850A. One that is on a middle left end side is a fifth color region 850E, and a sixth color region 850F, a seventh color region 850G, an eighth color region 850H are located in this order rightward from the fifth color region 850E. One that is on a lower left side is a ninth color region 850I, and a tenth color region 850J, an eleventh color region 850K, a twelfth color region 850L are located in this order rightward from the ninth color region 850I. The LEDs are arranged on the LED board such that the LED that is in the first color region 850A (the second color region 850B, the third color region 850C, the fourth color region 850D, the fifth color region 850E, the sixth color region 850F) and the LEDs that is in the twelfth color region 850L (the seventh color region 850G, the eighth color region 850H, the ninth color region 850I, the tenth color region 850J, the eleventh color region 850K) are arranged adjacent to each other. The first color region 850A (the second color region 850B, the third color region 850C, the fourth color region 850D, the fifth color region 850E, the sixth color region 850F) and the twelfth color region 850L (the seventh color region 850G, the eighth color region 850H, the ninth color region 850I, the tenth color region 850J, the eleventh color region 850K) are positioned symmetrically with respect to a center C of the twelve color regions 850A to 850L.

### Tenth Embodiment

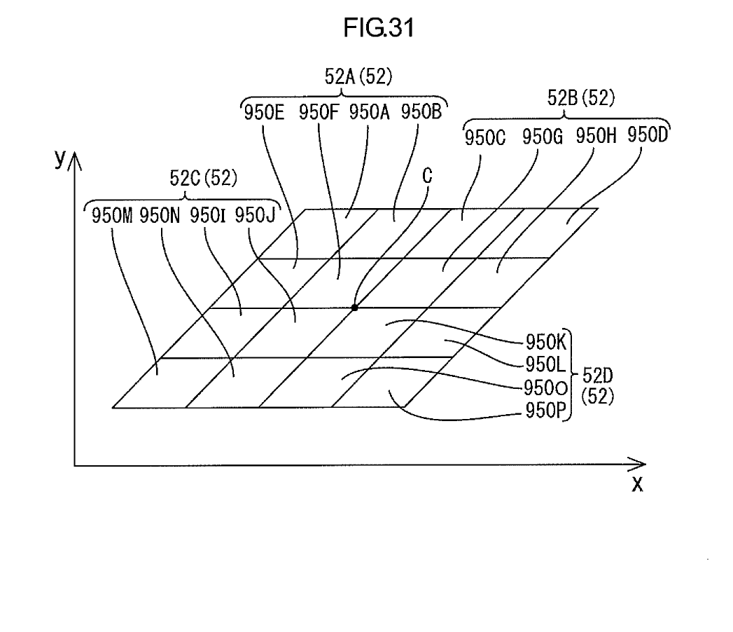

A tenth embodiment of the present invention will be described with reference to FIG. 31. In the tenth embodiment, the LEDs are classified into sixteen groups. The configurations, the operations, and the effects similar to those of the first embodiment will not be described.

In this embodiment, the LEDs are defined into sixteen groups based on the chromaticity of the emission light such that each of the LEDs is in one of sixteen color regions 950A to 950P that are adjacent to each other in the CIE 1931 chromaticity diagram. The sixteen color regions 950A to 950P are defined by dividing an entire chromaticity distribution area into sixteen regions in a substantially matrix. In FIG. 31, one that is on the upper left side is a first color region 950A, and a second color region 950B, a third color region 950C, a fourth color region 950D are located in this order rightward from the first color region 950A. One that is on the lower side of the first color region 950A and on the left end side is a fifth color region 950E, and a sixth color region 950F, a seventh color region 950G, an eighth color region 950H are located in this order rightward from the fifth color region 950E. One that is on the lower side of the fifth color region 950E and on the left end side is a ninth color region 950I, and a tenth color region 950J, an eleventh color region 950K, a twelfth color region 950L are located in this order rightward from the ninth color region 950I. One that is on the lower side of the ninth color region 950I is a thirteenth color region 950M, and a fourteenth color region 950N, a fifteenth color region 950O, a sixteenth color region 950P are located in this order rightward from the thirteenth color region 950M. The LEDs are mounted on the LED board such that the LEDs in the color regions that are positioned symmetrically with respect to a center C of the sixteen color regions 950A to 950L are adjacent to each other. Specifically, the first color region 950A (the second color region 950B, the third color region 950C, the fourth color region 950D, the fifth color region 950E, the sixth color region 950F, the seventh color region 950G, the eighth color region 950H) and the sixteenth color region 950P (the ninth color region 950I, the tenth color region 950J, the eleventh color region 950K, the twelfth color region 950L, the thirteenth color region 950M, the fourteenth color region 950N, the fifteenth color region 950O) are positioned symmetrically with respect to the center of the sixteen color regions.

The LEDs that are mounted on the LED board may be classified in a following method. Four of the sixteen color regions 950A to 950P that are located in a matrix are collectively defined as a collective color region 52. The entire chromaticity distribution area is defined into four collective color regions 52. Among the four collective color regions 52, one on the upper left side in FIG. 31 is a first collective color region 52A, one that is on the right side of the first collective color region 52A is a second collective color region 52B, one that is on the lower left side is a third collective color region 52C, and one that is on the right side of the third collective color region 52C is a fourth collective color region 52D. The first collective color region 52A includes the first color region 950A, the second color region 950B, the fifth color region 950E, the sixth color region 950F. The second collective color region 52B includes the third color region 950C, the fourth color region 950D, the seventh color region 950G, the eighth color region 950H. The third collective color region 52C includes the ninth color region 950I, the tenth color region 950J, the thirteenth color region 950M, the fourteenth color region 950N. The fourth collective color region 52D includes the eleventh color region 950K, the twelfth color region 950L, the fifteenth color region 950O, the sixteenth color region 950P. The LEDs are mounted on the Led board such that the LEDs in the collective color regions that are positioned symmetrically with respect to a center C of the four collective color regions 52A to 52D are mounted in adjacent to each other. The first collective color region 52A (the second collective color region 52B) and the fourth collective color region 52D (the third collective color region 52C) are positioned symmetrically with respect to the center C of the four collective color regions 52A to 52D.

### Other Embodiments

The present invention is not limited to the embodiments explained in the above description with reference to the drawings. The following embodiments may be included in the technical scope of the present invention, for example.

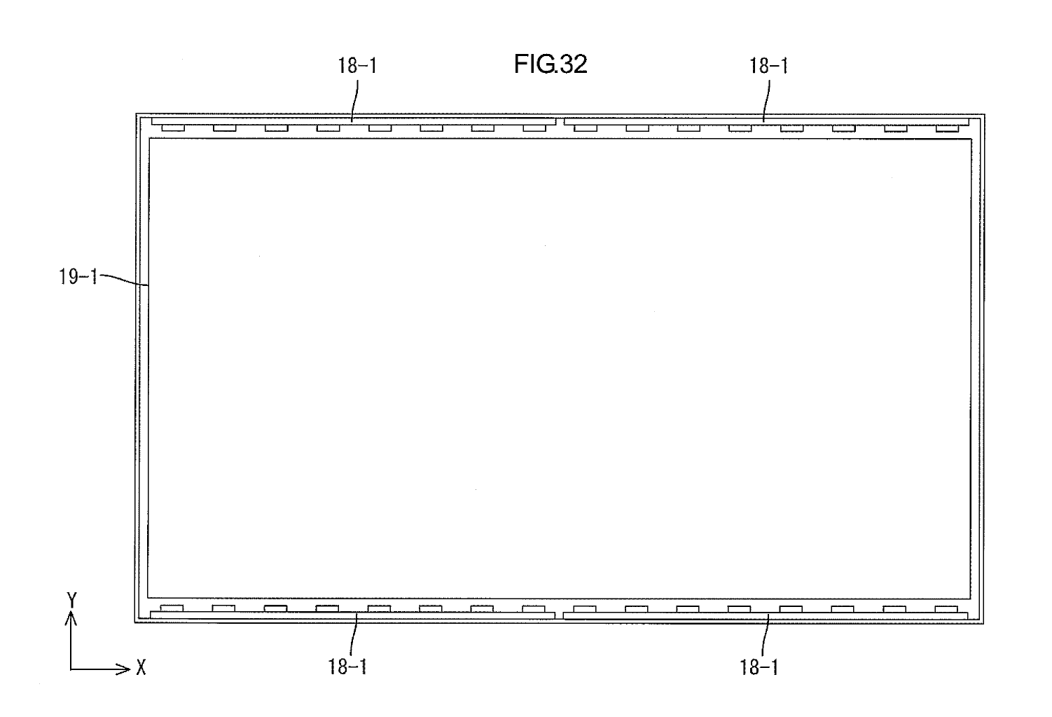

(1) Other than the above embodiments, the number of the LED boards included in the backlight unit or arrangement of the LED boards may be altered if necessary. For example, as illustrated in FIG. 32, two pairs of LED boards 18-1 (four LED boards) may be arranged to sandwich a light guide plate 19-1 with respect to a short-side direction.

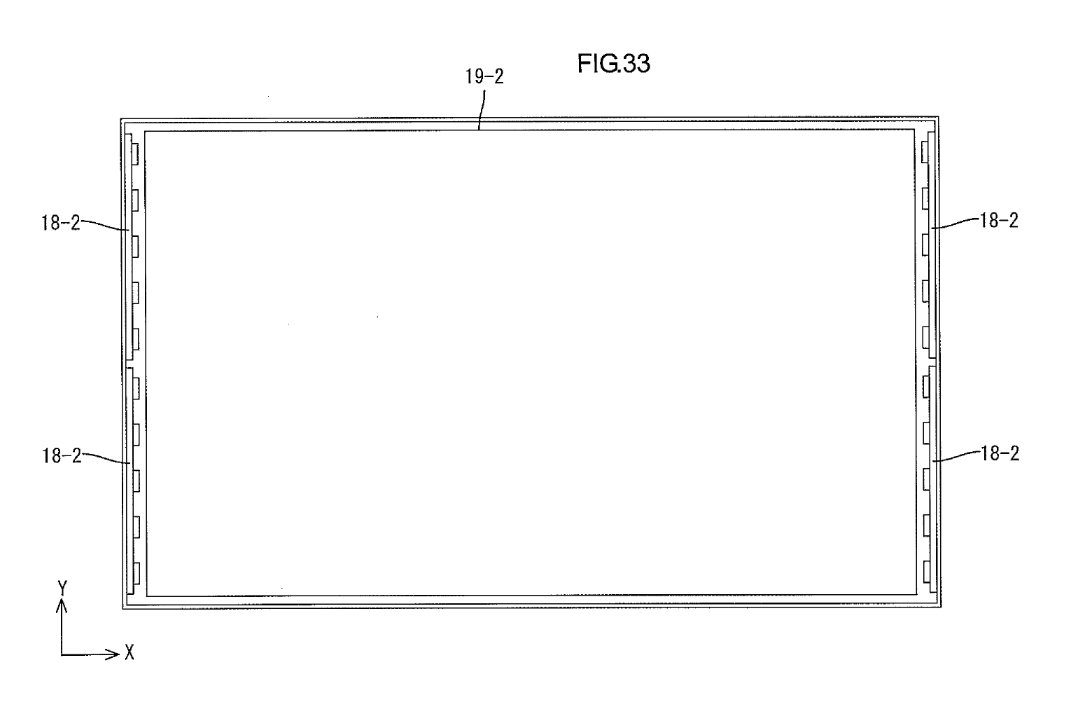

(2) Other than the embodiment (1), for example, as illustrated in FIG. 33, three pairs of LED boards 18-2 (six LED boards) may be arranged to sandwich a light guide plate 19-2 with respect to a short-side direction. The number of LED boards may be four pairs (eight LED boards) or more.

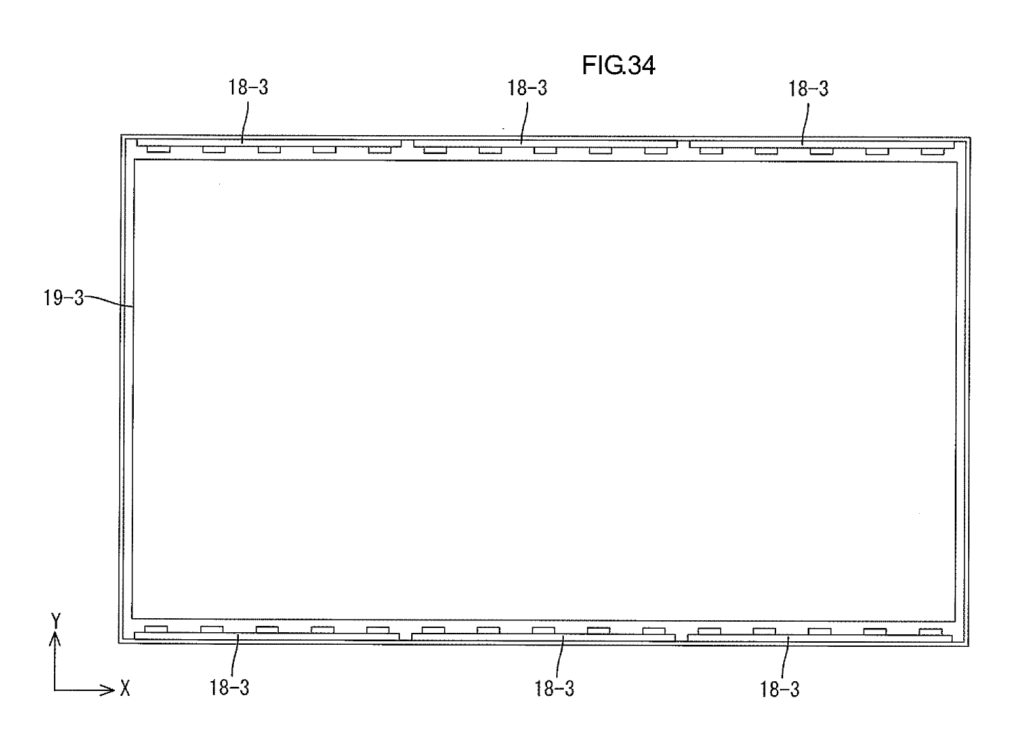

(3) Other than the embodiment (1), for example, as illustrated in FIG. 34, two pairs of LED boards 18-3 (four LED boards) may be arranged to sandwich a light guide plate 19-3 with respect to a long-side direction. As is described in the embodiment (2), the number of LED boards may be three pairs (six LED boards) or may be four pairs (eight Led boards) or more.

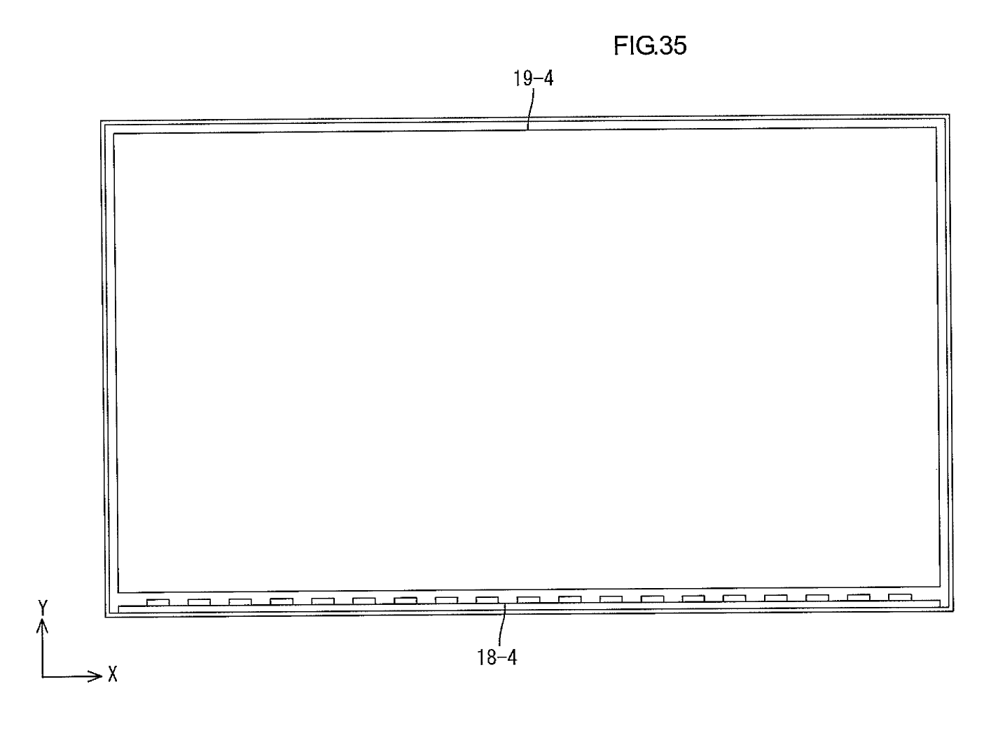

(4) Other than the embodiment (1), for example, as illustrated in FIG. 35, only one LED board 18-4 may be arranged along one long side of a light guide plate 19-4. One LED board may be arranged along one short side of a light guide plate.

(5) Other than the embodiments (1) to (4), the LED boards may be arranged on any three sides of the light guide plate. Further, the LED boards may be all of four sides of the light guide plate.

(6) In the above embodiments, the LEDs are classified into multiple groups based on the chromaticity of the emission light from each of the LEDs such that each of the LEDs is in one of multiple color regions. For example, the LEDs are classified into one of three, four, six, nine, twelve, and sixteen color regions. However, the number of color regions may be altered if necessary. The number of color regions may be twenty five, fifty, or one hundred, for example.

(7) In the tenth embodiment, the LEDs are arranged on the LED board with reference to the collective color regions each of which collectively includes multiple color regions. Such a mounting method is applied to each of the embodiments 1, 8 and 9. Such a mounting method may be used in a case where the number of divided color regions may be altered as described in the embodiment (6). For example, such a mount method is effectively applied of the number of divided color regions increases such as twenty five, fifty, or one hundred.

(8) In the second embodiment, only the four kinds of LEDs that are in the color regions that are diagonally positioned in the CIE 1931 chromaticity diagram are mounted on the LED board. However, in mounting the four kinds of LEDs on the LED board, the two kinds of LEDs (the first LEDs, the third LEDs, the seventh LEDs, the ninth LEDs) in the color regions that are diagonally positioned in the CIE 1931 chromaticity diagram and another two kinds of LEDs (the second LEDs, the fourth LEDs, the sixth LEDs, the eighth LEDs) in the color regions that are positioned symmetrically with respect to a center but not diagonally positioned may be mounted on the LED board. Only the other two kinds of LEDs in the color regions that are positioned symmetrically with respect to a center but not diagonally positioned may be mounted on the LED board. The LEDs may be mounted on the LED board with the above mounting method in the third embodiment.

(9) In the above first embodiment, any desired ones of the manufactured five kinds of LED boards (the first LED board to the fifth LED board) may be mounted to the backlight unit. Further, for example, the same kinds of the LED boards may be selected and mounted to the backlight unit. Only the LED boards (the first LED boards, the third LED boards) having the LEDs in the color regions that are diagonally positioned in the CIE 1931 chromaticity diagram may be selected and mounted to the backlight unit. Further, only the LED boards (the second LED boards, the fourth LED boards) having the LEDs in the color regions that are positioned symmetrically with respect to a center but not diagonally positioned may be selected and mounted to the backlight unit.

(10) In the above embodiments, the LED includes a green phosphor and a red phosphor as the phosphor. However, a color or the number of the phosphors included in the LED may be altered, if necessary. For example, the LED may include the green phosphor, the red phosphor, and a yellow phosphor that is excited by blue light from the LED component and emits yellow light having a yellow wavelength region (from approximately 570 nm to approximately 600 nm). α-SiAlON that is an example of a SiAlON-based phosphor may be used as an example of the yellow phosphor. The SiAlON-based phosphor is nitride. With such a configuration, yellow light is emitted with higher efficiency compared to a configuration using the phosphor that is sulfide or oxide. Specifically, the α-SiAlON includes europium (Eu) as the activator and is expressed by a general formula Mx (Si,Al)12(O,N)16:Eu (M represents metal ion, x represents a solid solution amount). For example, if calcium is used as the metal ion, the α-SiAlON is expressed by Ca(Si,Al)12(O,N)16:Eu.

(11) Other than the embodiment (10), only the yellow phosphors may be used as the phosphor that is included in the LED component emitting blue light.

(12) In the above embodiments, the LED components that emit blue light are included in the LEDs. However, LED components that emit other visible light may be included in the LEDs. For example, the LEDs may include LED components that emit violet light having a violet wavelength range (from approximately 420 nm to approximately 480 nm).

(13) If the LEDs include the LED components that emit violet light described in the embodiment (12), the configuration of the phosphor may be altered and specifically, the green phosphor, the red phosphor and the blue phosphor may be included in the LED as the phosphor. When being excited by the violet light from the LED component, the blue phosphor emits light having the main emission wavelength in the blue wavelength region (from approximately 570 nm to approximately 600 nm). La oxynitride blue phosphor (JEM blue phosphors) may be used as the blue phosphor. Specifically, the La oxynitride blue phosphor is oxynitride that is expressed by a general formula LaAl (Si8-z, Alz) N10-Oz. The La oxynitride blue phosphor contains La in the skeleton of (si, Al)—(O, N) 4 and a part of La is replaced with Ce3+. The La oxynitride blue phosphor includes Ce3+ as alight emission center.

(14) In the above embodiments, only one kind of phosphor that emits light of only one color is used as the phosphor included in the LED. However, two or more kinds of phosphors that emit the same color may be used as the phosphor included in the LED.

(15) In the above embodiments, β-SiAlON is used as the green phosphor included in the LED. However, different green phosphor may be used if necessary. For example, a YAG-based phosphor may be used as the green phosphor, and this increases light emission efficiency. The YAG-based phosphor is an yttrium-aluminum complex oxide having a garnet structure and expressed by a chemical formula: Y3Al5O12. The YAG-based phosphor includes rare-earth element (e.g., Ce, Tb, Eu, Nd) as an activator. The YAG-based phosphor may be Y3Al5O12:Ce, Y3Al5O12:Tb, (Y,Gd)3Al5O12:Ce, Y3(Al,Ga)5O12:Ce, Y3(Al,Ga)5O12:Tb, (Y,Gd)3(Al,Ga)5O12:Ce, (Y,Gd)3(Al,Ga)5O12:Tb, Tb3Al5O12:Ce.

Other than the above, for example, the green phosphor may be inorganic phosphors such as (Ba, Mg)Al10O17:Eu, Mn, SrAl2O4:Eu, Ba1.5Sr0.5SiO4:Eu, BaMgAl10O17:Eu, Mn, Ca3(Sc, Mg)2Si3O12:Ce, Lu3Al5O12:Ce, CaSc2O4:Ce, ZnS:Cu, Al, (Zn, Cd)S:Cu, Al, Y2SiO5:Tb, Zn2SiO4:Mn, (Zn, Cd)S:Cu, ZnS:Cu, Gd2O2S:Tb, (Zn, Cd)S:Ag, Y2O2S:Tb, (Zn, Mn)2SiO4, BaAl12O19:Mn, (Ba, Sr, Mg)O.aAl2O3:Mn, LaPO4:Ce, Tb, Zn2SiO4:Mn, CeMgAl11O19:Tb, and BaMgAl10O17:Eu, Mn.

(16) In the above embodiments, CaAlSiN is used as the red phosphor included in the LED. Other phosphors other than the CaAlSiN-based phosphors may be used as the red phosphor. For example, inorganic phosphors such as (Sr, Ca)AlSiN3:Eu, Y2O2S:Eu, Y2O3:Eu, Zn3(PO4)2:Mn, (Y, Gd, Eu)BO3, (Y, Gd, Eu)2O3, YVO4:Eu, and La2O2S:Eu, Sm may be used the red phosphor.

(17) In the embodiment (10), α-SiAlON is used as the yellow phosphor included in the LED. However, other yellow phosphors may be used if necessary. For example, BOSE-type Bose may be used as the yellow phosphor. BOSE includes europium (Eu) as the activator and is expressed by (Ba.Sr)2SiO4:Eu. Phosphors other than α-SiAlON and BOSE may be used as the yellow phosphor. For example, (Y,Gd)3Al3O12:Ce that is an example of the YAG-based phosphor may be used as the yellow phosphor, and this improves light emission efficiency. Tb3Al5O12:Ce may be used as the yellow phosphor.

(15) In the above embodiments, the LED components are manufactured so as to have the main emission wavelength of 445 nm. However, the specific target main emission wavelength may be altered if necessary.

(16) In the fifth embodiment, the coloring portions of the color filter include color portions of red, green, and blue that are three primary color of light and yellow. Instead of the yellow color portion, a cyan coloring portion may be included in the color filter. Other than the cyan color portion, a transparent portion that does not color transmitted light may be included in the color filter.

(17) The coloring portions of the four colors included in the color filter may be arranged in the row direction in a different order from the arrangement order of the fifth embodiment if necessary. The coloring portions of the four colors may not be arranged in the row direction but may be arranged in rows and columns.

(18) In the fifth embodiment, the area ratio of each of the four-colors coloring portions included in the color filter is different. However, the area ratio of the four-colors coloring portions may be same.

(19) In the above embodiments, the edge-light-type backlight unit including the light guide plate is described. However, the present invention may be applied to an edge-light-type backlight unit without including a light guide plate. In such an edge-light-type backlight unit, an optical lens (for example, a diffuser lens having diffusing capability) is used to provide light from the LED with an optical operation such that the light is irradiated evenly to a plate surface of the liquid crystal panel.

(20) In the above embodiments, the edge-light-type backlight unit is described. However, the present invention may be applied to a direct-type backlight unit.

(21) In the above embodiments, the TFT is used as the switching component of the liquid crystal display device. However, the liquid crystal display device may include switching components other than the TFTs (for example, thin film diode (TFD)). Further, the present invention may be applied to a black-and-white display liquid crystal display device other than the color-display liquid crystal display device.

(22) In the above embodiments, the liquid crystal display device includes the liquid crystal panel as the display panel. However, the display device may include other kind of display panel.

(23) In the above embodiments, the television device includes the tuner. However, the display device may not include the tuner.

(24) In the first to fourth embodiments, the chromaticity of the emission light from the LEDs is classified into nine color regions and two, four, five, or nine kinds of LEDs each of which is in different color regions are arranged on one LED board. However, three, six, seven, or eight kinds of LEDs each of which is in different color regions may be arranged on one LED board. If the chromaticity of the emission light from the LEDs is classified into any number of color regions other than nine (in the sixth to tenth embodiments and the embodiment (6)), the number of kinds of LEDs that are arranged on one LED board may be altered to the classified number or less.

(25) In the second embodiment, the LED board on which four kinds of LEDs are mounted is used in the liquid crystal display device where the ratio of the interval P between the LEDs and the distance L from the LEDs and a surface of the display area satisfies one of the formulae (2) to (4). The LED board on which five or nine kinds of LEDs are mounted as is in the third or fourth embodiment may be used in the liquid crystal display device similarly. If the number of kinds of LEDs mounted on the LED board is changed as is in the embodiment (24), such an LED board may be used in the liquid crystal display device similarly.

### EXPLANATION OF SYMBOLS

10: Liquid crystal display device (Display device), 11: Liquid crystal panel (Display panel), 12: Backlight unit (Lighting unit), 17, 117, 217, 317: LED (Light source), 18, 118, 218, 318: LED board (Light source board), 19: Light guide plate, 19a: Light exit surface (Plate surface), 19b: Light entrance surface (End surface), 40: LED component (Light emission component), 50, 550, 650, 750, 850, 950: Color region, 52: Collective color region (Color region), 429: Color filter, 429R, 429G, 429B, 429Y: Coloring portion, AA: Display area, C: Center, L: Distance, P: Interval, TV: Television device

1. A display device comprising:
a display panel displaying an image;
a lighting unit configured to irradiate the display panel with light;
a plurality of light sources that configure a light emission source of the lighting unit, and configured to be classified into at least three groups based on chromaticity of emission light such that each of the light sources is in one of at least three color regions that are arranged in adjacent to each other in a CIE 1931 chromaticity diagram; and
a light source board included in the lighting unit and on which the light sources are arranged such that at least two light sources in at least two color regions that are positioned symmetrically with respect to a center of the at least three color regions in the CIE 1931 chromaticity diagram are arranged in adjacent to each other.

2. The display device according to claim 1, wherein
the light sources are classified into at least four groups based on the chromaticity of the emission light such that each of the light sources is in one of at least four color regions that are arranged in a matrix in the CIE 1931 chromaticity diagram, and
at least two light sources in at least two of the at least four color regions that are diagonally positioned in the CIE 1931 chromaticity diagram are arranged in adjacent to each other on the light source board.

3. The display device according to claim 2, wherein the at least two light sources in the two of the at least four color regions that are diagonally positioned in the CIE 1931 chromaticity diagram are arranged alternately and in adjacent to each other on the light source board.

4. The display device according to claim 1, wherein the at least two light sources in the at least two color regions that are positioned symmetrically with respect to the center of the at least three color regions in the CIE 1931 chromaticity diagram are arranged alternately and in adjacent to each other on the light source board.

5. The display device according to claim 1, wherein
the light sources include a light source that is in the color region including the center of the at least three color regions in the CIE 1931 chromaticity diagram, and
the light source in the color region including the center of the at least three color regions is arranged on the light source board.

6. The display device according to claim 1, wherein the light source board is mounted such that the light sources are arranged locally near an end portion of the display panel of the lighting unit and arranged along the end portion of the display panel.

7. The display device according to claim 6, wherein
the light sources are classified into at least four kinds based on the chromaticity of the emission light such that each of the light sources is in one of the at least four color regions that are positioned in a matrix in the CIE 1931 chromaticity diagram,
the display panel includes a display area displaying an image, and a non-display area surrounding the display area, and
when a ratio of a distance L from the light source on the light source board to the display area and an interval P between the light sources on the light source board satisfies relation of a following formula (1),
L/P≧0.25 (1)
the at least four light sources in the at least four color regions that are positioned symmetrically with respect to the center of the at least four color regions in the CIE 1931 chromaticity diagram are arranged in adjacent to each other on the light source board.

8. The display device according to claim 6, wherein the lighting unit further includes a light guide plate having an end surface that faces the light sources and a plate surface that faces a plate surface of the display panel.

9. The display device according to claim 1, wherein the light source includes a light emission component that emits visible light and a phosphor that is excited by light from the light emission component and emits light.

10. The display device according to claim 9, wherein the light source includes the light emission component that emits blue light and the phosphor that is excited by the blue light from the light emission component and emits white light as a whole.

11. The display device according to claim 10, wherein the display panel further includes a color filter including coloring portions that provides blue, green, red, and yellow.

12. The display device according to claim 1, wherein the light source is an LED.

13. A television device comprising the display device according to claim 1.

14. A method of manufacturing a display device comprising:
a light source classification process in which light sources are classified into at least three groups based on chromaticity of emission light from each of the light sources such that each of the light sources is in one of at least three color regions that are positioned in adjacent to each other in the CIE 1931 chromaticity diagram;
a light source mount process in which at least two light sources in at least two color regions that are positioned symmetrically with respect to a center of the at least three color regions in the CIE 1931 chromaticity diagram are arranged in adjacent to each other on the light source board; and
a mount process in which the light source board is mounted to a lighting unit and a display panel is mounted to the lighting unit.
